(19) United States
(12) Patent Application Publication
(10) Pub. No.: US 2022/0275522 A1
(43) Pub. Date: Sep. 1, 2022

(54) SYSTEMS AND METHODS TO MAKE HYDROGEN GAS USING METAL SALT

(71) Applicant: Verdagy, Inc., Moss Landing, CA (US)

(72) Inventors: Kyle Self, San Jose, CA (US); Ryan J. Gilliam, San Jose, CA (US); Thomas Albercht, Santa Clara, CA (US)

(21) Appl. No.: 17/659,238

(22) Filed: Apr. 14, 2022

Related U.S. Application Data
(63) Continuation of application No. 17/653,043, filed on Mar. 1, 2022.
(60) Provisional application No. 63/249,127, filed on Sep. 28, 2021.
(60) Provisional application No. 63/155,178, filed on Mar. 1, 2021.

(51) Int. Cl. C25B 1/04; C25B 9/19; C25B 9/70; C25B 15/08

(52) U.S. Cl. CPC C25B 1/04; C25B 9/19; C25B 9/70; C25B 15/081

(57) ABSTRACT

Disclosed herein are methods and systems that relate to forming a metal hydroxy salt from metal salt at an anode and generate hydrogen gas at the cathode. The metal hydroxy salt is then subjected to a thermal reaction or another electrochemical reaction to form oxygen gas as well as to regenerate the metal salt.

### CROSS-REFERENCE TO RELATED APPLICATION

This application claims the benefit of priority to U.S. patent application Ser. No. 17/653,043, filed Mar. 1, 2022, which claims the benefit of priority to U.S. Provisional Patent Application Ser. No. 63/155,178, filed Mar. 1, 2021, and to U.S. Provisional Application Ser. No. 63/249,127, filed Sep. 28, 2021, the disclosures of which are incorporated by reference herein in their entireties.

### BACKGROUND

As electricity production migrates to lower CO₂ footprint technologies, the ability to convert electricity into low-carbon/zero-carbon transportation fuels has become an increasingly important challenge in mitigating global CO₂ emissions. Among the options for such fuels, hydrogen (H₂) may have a unique advantage in that its oxidation product is water. Thus, hydrogen represents a low-carbon transportation fuel if it can be manufactured with a low-carbon footprint.

Hydrogen may be generated as a co-product in a number of industrially important processes such as steam cracking and the chlor-alkali process. On-purpose hydrogen production may be typically accomplished via a process known as steam-methane reforming (SMR), which converts the hydrogen atoms in both methane and water to hydrogen gas. Although this process can produce large amounts of hydrogen, the carbon atoms that were initially present in the methane ultimately leave the process as CO₂ emissions. Any effort to use hydrogen as a zero-carbon or low carbon transportation fuel would require another process.

### SUMMARY

There are provided methods and systems herein that relate to the production of hydrogen gas and other commercially valuable products.

The present disclosure describes a method to generate hydrogen gas, the method comprising:
providing an anode and an anode electrolyte comprising a metal salt in an electrochemical cell and forming a metal hydroxy salt at the anode;
providing a cathode and a cathode electrolyte in the electrochemical cell; and
forming hydrogen gas at the cathode.

In some examples, the method further comprises transferring at least a portion of the anode electrolyte comprising the metal hydroxy salt to a thermal reactor or to a second electrochemical cell to generate oxygen gas and regenerate the metal salt.

The present disclosure also describes a method to generate hydrogen gas, the method comprising:
providing an anode and an anode electrolyte comprising a metal salt in an electrochemical cell;
forming a metal hydroxy salt at the anode;
providing a cathode and a cathode electrolyte in the electrochemical cell;
forming hydrogen gas at the cathode;
transferring at least a portion of the anode electrolyte comprising the metal hydroxy salt outside the electrochemical cell; and
subjecting the anode electrolyte comprising the metal hydroxy salt to a thermal reaction to form oxygen gas.

In some examples, the method further comprises oxidizing the metal ion of the metal salt from a lower oxidation state to a higher oxidation state at the anode to form the metal hydroxy salt. In some examples, the method further comprises reducing water at the cathode to form hydroxide ions and the hydrogen gas. In some examples, the method further comprises migrating hydroxide ions from the cathode electrolyte to the anode electrolyte. In some examples, the method further comprises forming the metal hydroxy salt from the metal salt and the hydroxide ions in the anode electrolyte.

In some examples, the method further comprises oxidizing the metal ion of the metal salt from a lower oxidation state to a higher oxidation state at the anode to form the metal hydroxy salt and hydrogen ions. In some examples, the method further comprises transporting the hydrogen ions from the anode electrolyte to the cathode electrolyte and reducing the hydrogen ions at the cathode to form the hydrogen gas.

In some examples, the thermal reaction also forms the metal salt with the metal ion in the lower oxidation state.

In some examples, the method further comprises re-circulating the metal salt with the metal ion in the lower oxidation state back to the anode electrolyte in the electrochemical cell.

In some examples, the anode electrolyte further comprises hydroxide ions.

In some examples, the pH of the anode electrolyte is more than 10.

In some examples, the electrochemical cell has a theoretical voltage of less than 2 V.

In some examples, no oxygen gas is formed at the anode or less than 25% of the Faradaic efficiency is for the oxygen evolution reaction at the anode.

In some examples, the thermal reaction is carried out in presence of hydroxide ions.

In some examples, an operating voltage of the electrochemical cell is lower than an operating voltage of a cell that forms oxygen gas at the anode. In some examples, the operating voltage of the electrochemical cell is lower than the operating voltage of a cell that forms oxygen gas at the anode due to one or more of lower over-potential, lower thermo-neutral voltage, lower half-cell potential, or combinations thereof.

In some examples, the anode electrolyte further comprises salt. In some examples, the salt is an alkali metal halide, an alkali earth metal halide, a lanthanide halide, or a combination thereof.

In some examples, the method further comprises separating the anode from the cathode by an anion exchange membrane.

In some examples, the anode electrolyte further comprises water and the metal salt is partially or fully soluble in the anode electrolyte.

In some examples, the method further comprises separating the metal salt from the anode electrolyte before and/or after the thermal reaction.

In some examples, the metal ion in the metal salt or the metal hydroxy salt is selected from the group consisting of: manganese, iron, chromium, selenium, copper, tin, silver, cobalt, uranium, lead, mercury, vanadium, bismuth, titanium, ruthenium, osmium, europium, zinc, cadmium, gold, nickel, palladium, platinum, rhodium, iridium, technetium, rhenium, molybdenum, tungsten, niobium, tantalum, zirconium, hafnium, and combination thereof. In some examples, the metal ion in the metal salt or the metal hydroxy salt is selected from the group consisting of: manganese, chromium, copper, iron, tin, selenium, tantalum, and combinations thereof.

In some examples, the metal salt with the metal ion in the lower oxidation state is selected from the group consisting of: CuCI, CuBr, CuI, FeCl₂, FeBr₂, FeI₂, SnCl₂, SnBr₂, SnI₂, Cu₂SO₄, FeSO₄, SnSO₄, Cu₃PO₄, Fe₃(PO₄)₂, and Sn₃(PO₄)₂.

In some examples, the metal hydroxy salt with the metal ion in the higher oxidation state is selected from the group consisting of: Cu(OH)ₓCl_{y}, Cu(OH)ₓBr_{y}, Cu(OH)ₓI_{y}, Fe(OH)ₓCl_{y}, Fe(OH)ₓBr_{y}, Fe(OH)ₓI_{y}, Sn(OH)ₓI_{y}, Sn(OH)ₓCl_{y}, Sn(OH)ₓI_{y}, Cu₂(OH)ₓ(SO₄)_{y}, Fe(OH)ₓ(SO₄)_{y}, Sn(OH)ₓ(SO₄)_{y}, Cu₃(OH)ₓ(PO₄)_{y}, Fe₃(OH)ₓ(PO₄)_{y}, and Sn₃(OH)ₓ(PO₄)_{y}, wherein x and y are integers and add to balance the charge on the metal.

In some examples,
the metal salt with the metal ion in the lower oxidation state is CuCI and the metal hydroxy salt with the metal ion in the higher oxidation state is Cu(OH)ₓCl_{y};
the metal salt with the metal ion in the lower oxidation state is CuBr and the metal hydroxy salt with the metal ion in the higher oxidation state is Cu(OH)ₓBr_{y};
the metal salt with the metal ion in the lower oxidation state is CuI and the metal hydroxy salt with the metal ion in the higher oxidation state is Cu(OH)ₓI_{y};
the metal salt with the metal ion in the lower oxidation state is FeCl₂ and the metal hydroxy salt with the metal ion in the higher oxidation state is Fe(OH)ₓCl_{y};
the metal salt with the metal ion in the lower oxidation state is FeBr₂ and the metal hydroxy salt with the metal ion in the higher oxidation state is Fe(OH)ₓBr_{y}; or
the metal salt with the metal ion in the lower oxidation state is FeI₂ and the metal hydroxy salt with the metal ion in the higher oxidation state is Fe(OH)ₓI_{y},
wherein x, and y are integers.

In some examples, the metal hydroxy salt with the metal ion in the higher oxidation state is Mₓ^{m+}X_{y}(OH)_{(mx-y)}, MₓX_{y}(OH)_{(2x-y)}, MₓS_{y}(OH)_{(3x-y)}, MₓX_{y}(OH)_{(4x-y)}, or combinations thereof, wherein M is the metal ion, X is a counter anion, and m, x, and y are integers. In some examples, the counter anion is a halide ion, a sulfate ion, or a phosphate ion.

In some examples, the concentration of the metal salt with the metal ions in the lower oxidation state is from about 0.1 M to about 1 M.

In some examples, the concentration of the metal salt with the metal ions in the higher oxidation state is from about 0.2 M to about 1.5 M.

In some examples, the operating voltage of the electrochemical cell is from about 1.5 V to about 2.5 V.

In some examples, the temperature of the electrochemical cell is from about 50° C. to about 100° C.

In some examples, the method further comprises carrying out the thermal reaction in presence of hydroxide ions. In some examples, the hydroxide ions are present as an alkali metal hydroxide or an alkali earth metal hydroxide.

In some examples, the method further comprises carrying out the thermal reaction at a pH of more than about 10.

In some examples, the method further comprises carrying out the thermal reaction in the presence of a catalyst. In some examples, the catalyst is a metal oxide. In some examples, the metal oxide is manganese oxide, ruthenium oxide, silicon oxide (e.g., SiO₂), iron oxide (e.g., Fe₂O₃), aluminum oxide (e.g., Al₂O₃), or a combination thereof.

In some examples, the temperature of the thermal reaction is from about 50° C. to about 500° C.

In some examples, the method further comprises providing a portion or all of the heat used in the thermal reaction from another process selected from the group consisting of: waste heat and/or clean source of heat selected from a solar thermal process, a geothermal process, and/or a nuclear process.

In some examples, the method further comprises providing a portion or all of heat used in the thermal reaction from heat generated by compression of the hydrogen gas.

In some examples, the method further comprises providing a heat exchanger between the electrolysis cell and the thermal reaction that serves to recover heat from solution leaving the thermal reaction into a stream entering the thermal reaction.

in some examples, the method further comprises operating at least one of the electrochemical cell or the thermal reaction at elevated pressure.

In some examples, operating the electrochemical cell at an elevated pressure reduces cost of compression of the hydrogen gas and operating the thermal process at a lower pressure facilitates oxygen evolution.

In some examples, the electrochemical cell is operated at a pressure of from about 40 psi to about 500 psi.

In some examples, the thermal reaction is operated at a pressure of from about 14 psi to about 300 psi.

in some examples, the counter anion in the metal salt or the metal hydroxy salt is a halide ion, a sulfate ion, or a phosphate ion.

In some examples, the method further comprises maintaining a steady-Mate pH differential of greater than about 1 between the anode electrolyte and the cathode electrolyte, such as a pH differential of from about 1 to about 6.

The present disclosure also describes a method to generate hydrogen gas, the method comprising:
providing a first anode and a first anode electrolyte comprising a metal salt in a first electrochemical cell;
oxidizing the metal salt to a metal hydroxy salt at the first anode;
providing a first cathode and a first cathode electrolyte in the first electrochemical cell and forming hydrogen gas at the first cathode;
transferring at least a portion of the first anode electrolyte comprising the metal hydroxy salt outside the first electrochemical cell to a second cathode electrolyte of a second electrochemical cell;
reducing the metal hydroxy salt at a second cathode of the second electrochemical cell;
migrating hydroxide ions from the second cathode electrolyte to a second anode electrolyte of the second electrochemical cell through an AEM in the second electrochemical cell; and
oxidizing the hydroxide ions at a second anode in the second electrochemical cell to form oxygen gas.

The present disclosure also describes a system to generate hydrogen gas, the system comprising:
an electrochemical cell comprising;
   an anode and an anode electrolyte comprising a metal salt with a metal ion in a lower oxidation state, wherein the anode is configured to oxidize the metal salt with the metal ion in the lower oxidation state to a metal hydroxy salt with the metal ion in a higher oxidation state;
   a cathode and a cathode electrolyte comprising water, wherein the cathode is configured to reduce water to form hydroxide ions and hydrogen gas; and
   an anion exchange membrane configured to transport hydroxide ions from the cathode electrolyte to the anode electrolyte; and
a thermal reactor operably connected to the electrochemical cell, wherein the thermal reactor is configured to receive at least a portion of the anode electrolyte comprising the metal hydroxy salt and subject the portion of the anode electrolyte comprising the metal hydroxy salt to a thermal reaction to form oxygen gas and the metal salt with the metal ion in the lower oxidation state.

The present disclosure also describes a system to generate hydrogen gas, the system comprising:
an electrochemical cell comprising;
   an anode and an anode electrolyte comprising a metal salt with a metal ion in a lower oxidation state and water, wherein the anode is configured to oxidize the metal salt with the metal ion in the lower oxidation state to a metal hydroxy salt with the metal ion in a higher oxidation state and hydrogen ions;
   a cathode and a cathode electrolyte, wherein the cathode is configured to reduce hydrogen ions to form hydrogen gas; and
   a cation exchange membrane between the anode and a cathode, wherein the cation exchange membrane is configured to transport the hydrogen ions from the anode electrolyte to cathode electrolyte; and
a thermal reactor operably connected to the electrochemical cell, wherein the thermal reactor is configured to receive at least a portion of the anode electrolyte comprising the metal hydroxy salt and subject the portion of the anode electrolyte comprising the metal hydroxy salt to a thermal reaction to form oxygen gas and the metal salt with the metal ion in the lower oxidation state

The present disclosure also describes a system to generate hydrogen gas, the system comprising:
a first electrochemical cell comprising;
   a first anode and a first anode electrolyte comprising a metal salt with a metal ion in a lower oxidation state, wherein the first anode is configured to oxidize the metal salt with the metal ion in the lower oxidation state to a metal hydroxy salt with the metal ion in a higher oxidation state;
   a first cathode and a first cathode electrolyte comprising water, wherein the first cathode is configured to reduce water to form hydroxide ions and hydrogen gas; and
   a first anion exchange membrane configured to transport the hydroxide ions from the first cathode electrolyte to the first anode electrolyte; and
a second electrochemical cell operably connected to the first electrochemical cell, the second electrochemical cell comprising;
   a second anode and a second anode electrolyte;
   a second cathode and a second cathode electrolyte, wherein the second cathode electrolyte is configured to receive at least a portion of the first anode electrolyte comprising the metal hydroxy salt with the metal ion in the higher oxidation state, and wherein the second cathode is configured to reduce the metal hydroxy salt with the metal ion in the higher oxidation state to the metal salt with the metal ion in the lower oxidation state.

In some examples, the second electrochemical cell further comprises a second anion exchange membrane (AEM) configured to transfer hydroxide ions from the second cathode electrolyte to the second anode electrolyte of the second electrochemical cell, wherein the second anode is configured to oxidize the hydroxide ions to form oxygen gas.

The present disclosure describes a method to generate hydrogen gas, the method comprising:
providing an anode and an anode electrolyte comprising a metal salt in an electrochemical cell;
oxidizing a metal ion of the metal salt from a lower oxidation state to a higher oxidation state to form a metal hydroxy salt;
providing a cathode and a cathode electrolyte in the electrochemical cell; and
forming hydrogen gas and hydroxide ions at the cathode.

In some examples, the method further comprises separating the anode electrolyte from the cathode electrolyte with an anion exchange membrane and migrating hydroxide ions from the cathode electrolyte to the anode electrolyte. In some examples, the metal ion in the metal salt or the metal hydroxy salt is selected from the group consisting of: manganese, iron, chromium, selenium, copper, tin, silver, cobalt, uranium, lead, mercury, vanadium, bismuth, titanium, ruthenium, osmium, europium, zinc, cadmium, gold, nickel, palladium, platinum, rhodium, iridium, technetium, rhenium, molybdenum, tungsten, niobium, tantalum, zirconium, hafnium, and combination thereof. In some examples, the metal salt is selected from the group consisting of: CuCl, CuBr, Cut FeCl₂, FeBr₂, FeI₂, SnCl₂, SnBr₂, SnI₂, Cu₂SO₄, FeSO₄, SnSO₄, Cu₃PO₄, Fe₃(PO₄)₂, and Sn₃(PO₄)₂ and combinations thereof. In some examples, the metal hydroxy salt is selected from the group consisting of: Cu(OH)ₓCl_{y}, Cu(OH)ₓBr_{y}, Cu(OH)ₓI_{y}, Fe(OH)ₓCl_{y}, Fe(OH)ₓBr_{y}, Fe(OH)ₓI_{y}, Sn(OH)ₓCl_{y}, Sn(OH)ₓBr_{y}, Sn(OH)ₓI_{y}, Cu₂(OH)ₓ(SO₄)_{y}, Fe(OH)ₓ(SO₄)_{y}, Sn(OH)ₓ(SO₄)_{y}, Cu₃(OH)ₓ(PO₄)_{y}, Fe₃(OH)ₓ(PO₄)_{y}, and Sn₃(OH)ₓ(PO₄)_{y}, and combinations thereof, wherein x and y are integers and add to balance the charge on the metal. In some examples, the metal hydroxy salt with the metal ion in the higher oxidation state is Mₓ^{m+}X_{y}(OH)_{(mx-y)}, MₓY_{y}(OH)_{(2x-y)}, MₓX_{y}(OH)_{(3x-y)}, MₓX_{y}(OH)_{(4x-y)}, or combinations thereof, wherein M is the metal ion, X is a counter anion, and m, x, and y are integers. In some examples, the counter anion in the metal salt or the metal hydroxy salt is a halide ion, a sulfate ion, or a phosphate ion. In some examples, the method further comprises maintaining a steady-state pH differential of from about 1 to about 6 between the anode electrolyte and the cathode electrolyte. In some examples, no oxygen gas is formed at the anode or less than 25% of the Faradaic efficiency is for the oxygen evolution reaction at the anode. In some examples, the method further comprises oxidizing hydroxide ions at the anode to form oxygen gas. In some examples, the method further comprises operating the electrochemical cell at a lower current density for the oxidation of the metal salt with the metal ion in the lower oxidation state to the metal hydroxy salt with the metal ion in the higher oxidation state at the anode; and operating the electrochemical cell at a higher current density for the oxidation of the hydroxide ions at the anode to form oxygen gas. In some examples, the method further comprises transferring at least a portion of the anode electrolyte comprising the metal hydroxy salt outside the electrochemical cell; and subjecting the portion of the anode electrolyte comprising the metal hydroxy salt to a thermal reaction to form oxygen gas and the metal salt with the metal ion in the lower oxidation state. In some examples, the method further comprises re-circulating the metal salt with the metal ion in the lower oxidation state back to the anode electrolyte in the electrochemical cell. In some examples, the method further comprises carrying out the thermal reaction in presence of the hydroxide ions; at a pH of more than 10; and/or in presence of a catalyst. In some examples, the method further comprises transferring at least a portion of the anode electrolyte comprising the metal hydroxy salt outside the electrochemical cell to a second cathode electrolyte of a second electrochemical cell; and reducing the metal hydroxy salt at a second cathode of the second electrochemical cell to form the metal salt. In some examples, the method further comprises migrating hydroxide ions from the second cathode electrolyte to a second anode electrolyte of the second electrochemical cell through a second EM in the second electrochemical cell; and oxidizing hydroxide ions at a second anode in the second electrochemical cell to form oxygen gas.

The present disclosure also describes a system to generate hydrogen gas, the system comprising:
an electrochemical cell comprising;
   an anode and an anode electrolyte comprising a metal salt with a metal ion in a lower oxidation state, wherein the anode is configured to oxidize the metal salt with the metal ion in the lower oxidation state to a metal hydroxy salt with the metal ion in a higher oxidation state;
   a cathode and a cathode electrolyte comprising water, wherein the cathode is configured to reduce water to form hydroxide ions and hydrogen gas; and
   an anion exchange membrane configured to transport hydroxide ions from the cathode electrolyte to the anode electrolyte.

In some examples, the system further comprises a thermal reactor operably connected to the electrochemical cell and configured to receive at least a portion of the anode electrolyte comprising the metal hydroxy salt and subject the portion of the anode electrolyte comprising the metal hydroxy salt to a thermal reaction to form oxygen gas and the metal salt with the metal ion in the lower oxidation state. In some examples, the anode is further configured to oxidize the hydroxide ions at the anode to form oxygen gas. In some examples, the system further comprises a second electrochemical cell operably connected to the electrochemical cell, wherein the second electrochemical cell comprising a second anode and a second anode electrolyte, a second cathode and a second cathode electrolyte, wherein the second cathode electrolyte of the second electrochemical cell is configured to receive at least a portion of the anode electrolyte of the electrochemical cell comprising the metal hydroxy salt with the metal ion in the higher oxidation state, and wherein the second cathode in the second electrochemical cell is configured to reduce the metal hydroxy salt with the metal ion in the higher oxidation state to the metal salt with the metal ion in the lower oxidation state.

### BRIEF DESCRIPTION OF THE DRAWINGS

The drawings illustrate generally, by way of example, but not by way of limitation, various embodiments discussed in the present document.

FIG. 1 is an illustration of an example system for the formation of hydrogen gas at a cathode; oxidation of a metal salt to a metal hydroxy salt at an anode; and transfer of the anode electrolyte comprising the metal hydroxy salt to a thermal reactor or a thermal oxygen evolution unit to regenerate the metal salt and form oxygen gas.

FIG. 2 is an illustration of an example system for the formation of hydrogen gas and hydroxide ions at a cathode; migration of the hydroxide ions from a cathode electrolyte to an anode electrolyte; oxidation of a metal salt to a metal hydroxy salt at an anode; and transfer of the anode electrolyte comprising the metal hydroxy salt to a thermal reactor or a thermal oxygen evolution unit.

FIG. 3 is an illustration of an example system for the formation of hydrogen gas and hydroxide ions at a cathode in a first electrochemical cell; migration of the hydroxide ions from a cathode electrolyte to an anode electrolyte in the first electrochemical cell; oxidation of a metal salt to a metal hydroxy salt at an anode of the first electrochemical cell; and transfer of the anode electrolyte comprising the metal hydroxy salt to a cathode electrolyte of a second electrochemical cell to regenerate the metal salt and form oxygen gas.

FIG. 4 is an illustration of an example system for the formation of hydrogen ions and a metal hydroxy salt at an anode; migration of the hydrogen ions from an anode electrolyte to a cathode electrolyte; formation of hydrogen gas at a cathode; and transfer of the anode electrolyte comprising the metal hydroxy salt to a thermal reactor or a thermal oxygen evolution unit.

FIG. 5 is an illustration of an example system for the formation of hydrogen gas at a cathode; oxidation of a metal salt to a metal hydroxy salt at an anode; oxidation of hydroxide ions at the anode to form oxygen gas; and transfer of the anode electrolyte comprising the metal hydroxy salt to a thermal reactor or a thermal oxygen evolution unit and/or a second electrochemical cell to regenerate the metal salt and form oxygen gas.

### DETAILED DESCRIPTION

Disclosed herein are systems and methods that relate to environmentally friendly and low cost production of hydrogen gas and other commercially valuable products. Other commercially valuable products can include, but are not limited to, oxygen gas.

Hydrogen gas is formed electrochemically by a water splitting reaction where water is split into oxygen gas and hydrogen gas at an anode and a cathode of an electrochemical cell, respectively. Examples of such electrochemical processes include, without limitation, proton electrolyte membrane (PEM) electrolysis and alkaline water electrolysis (AWE). However, in such electrochemical reactions, operating energy of the cell is relatively high due to additional energy costs as a result of various energy inefficiencies. For example, to reduce unwanted migration of ionic species between the electrodes, the cathode and the anode may be separated by a component, such as a diaphragm or a membrane, which may reduce these migrations. Although the components may improve the overall efficiency of the cell, they may come at a cost of additional resistive losses in the cell which in turn may increase the operating voltage. Other inefficiencies in water electrolysis may include solution resistance losses, electric conduction inefficiencies and/or electrode over-potentials, among others. These various inefficiencies and the capital costs associated with reducing them may play an important role in the economic viability of hydrogen generation via water splitting electrolysis.

In addition to the energy costs associated with the water splitting reaction as noted above, another important cost may be the cost of hydrogen compression. To be adopted as a viable transportation fuel, the hydrogen produced by water splitting electrolysis may also be delivered to fueling stations. For the delivery process to be practicable, the hydrogen generated by the water splitting electrolysis is compressed for transport and refueling. If hydrogen is to be used as a transportation fuel at scale, the refueling pressure may be expected to be from about 5,000 psi to about 10,000 psi. As a result, compression costs may represent a significant percentage of the overall cost of hydrogen gas production by electrolysis.

The methods and systems described herein relate to a unique combination of electrochemical and thermochemical or thermal processes and/or a combination of two or more electrochemical reactions that when combined result in efficient, low cost, and low energy production of hydrogen gas. In some examples, the electrochemical reaction may take place in an acidic medium or may take place in an alkaline medium, as is described below.

As will be appreciated by those having skill in the art, it is to be understood that the invention is not limited to particular embodiments described herein, as such may, of course, vary. It is also to be understood that the terminology used herein is for the purpose of describing particular example embodiments only and is not intended to be limiting.

Where a range of values is provided, it is understood that each intervening value, to the tenth of the unit of the lower limit unless the context clearly dictates otherwise, between the upper and lower limit of that range and any other stated or intervening value in that stated range, is encompassed within the range. The upper and lower limits of these smaller ranges may independently be included in the smaller ranges, subject to any specifically excluded limit in the stated range. Where the stated range includes one or both of the limits, ranges excluding either or both of those included limits are also included in the range.

The term “about,” as used herein, can allow for a degree of variability in a value or range, for example, within 10%, within 5%, within 1%, within 0.5%, within 0.1% within 0.05%, within 0.01%, within 0.005%, or within 0,001% of a stated value or of a stated limit of a range, and includes the exact stated value or limit of the range.

The term “substantially” as used herein refers to a majority of, or mostly, such as at least about 50%, 60%, 70%, 80%, 90%, 95%, 96%, 97%, 98%, 99%, 99.5%, 99.9%, 99.99%, or at least about 99.999% or more, or 100%.

Unless defined otherwise, all technical and scientific terms used herein have the same meaning as commonly understood by one of ordinary skill in the art. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a,” “an,” and “the” include plural references unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual examples described and illustrated herein have discrete components and features which may be readily separated from or combined with the features of any of the other several examples without departing from the scope or spirit of the present invention. Any recited method can be carded out in the order of events recited or in any other order which is logically possible.

### Methods and Systems

Various methods and systems are described herein to produce hydrogen gas at a cathode and various reactions can be carried out at an anode, such as but not limited to: oxidation of a metal salt, formation of oxygen gas, or a combination thereof.

In one aspect, a method to generate hydrogen gas comprises:
providing an anode and an anode electrolyte comprising a metal salt in an electrochemical cell;
forming a metal hydroxy salt at the anode;
providing a cathode and a cathode electrolyte in the electrochemical cell; and
forming hydrogen gas at the cathode.

In some examples, at least a portion of the anode electrolyte comprising the metal hydroxy salt is transferred outside the electrochemical cell and is either reduced thermally (e.g., in a thermal reactor) and/or electrochemically (e.g., in a second electrochemical cell) to form oxygen gas and a reduced form of the metal hydroxy salt, i.e., the metal salt. Both the thermal reaction/reactor as well as the electrochemical reaction/cell to form oxygen gas are described in more detail below, The thermal reaction/reactor and the second electrochemical reaction/cell to form oxygen gas may be carried out simultaneously (both the thermal reaction and the second electrochemical reaction being carried out simultaneously), serially (both the thermal reaction and the second electrochemical reaction being carried out one after the other), or independently and all of these combinations are well within the scope of this disclosure.

In some examples, the method further comprises transferring at least a portion of the anode electrolyte comprising the metal hydroxy salt outside the electrochemical cell, and subjecting the portion of the anode electrolyte composing the metal hydroxy salt to the thermal reaction to form the oxygen gas.

In some examples, the method further comprises transferring at least a portion of the anode electrolyte comprising the metal hydroxy salt outside the first electrochemical cell to a second cathode electrolyte of a second electrochemical cell, reducing the metal hydroxy salt to the metal salt at the second cathode of the second electrochemical cell, migrating hydroxide ions from the second cathode electrolyte to a second anode electrolyte of the second electrochemical cell through a second AEM in the second electrochemical cell, and oxidizing the hydroxide ions at a second anode in the second electrochemical cell to form oxygen gas.

In one aspect, a system to generate hydrogen gas comprises:
an electrochemical cell comprising;
   an anode and an anode electrolyte comprising a metal salt, wherein the anode is configured to form a metal hydroxy salt from the metal salt; and
   a cathode and a cathode electrolyte comprising water, wherein the cathode is configured to form hydrogen gas.

In some examples, the system further comprises a thermal reactor operably connected to the electrochemical cell, wherein the thermal reactor is configured to receive at least a portion the anode electrolyte comprising the metal hydroxy salt and subject the portion of the anode electrolyte to a thermal reaction to form the oxygen gas and the metal salt.

In some examples, the system further comprises a second electrochemical cell operably connected to the first electrochemical cell, wherein the second electrochemical cell comprises a second anode and a second anode electrolyte, a second cathode and a second cathode electrolyte, wherein the second cathode electrolyte is configured to receive at least a portion of the first anode electrolyte of the first electrochemical cell comprising the metal hydroxy salt with the metal ion in the higher oxidation state, and wherein the second cathode of the second electrochemical cell is configured to reduce the metal hydroxy salt with the metal ion in the higher oxidation state to the metal salt with the metal ion in the lower oxidation state.

The hydrogen gas may be captured and stored for commercial purposes. The oxygen gas may be vented out or captured and stored for commercial purposes.

The term “metal salt,” as used herein, may be represented as “MX” where Nil is the metal ion and X is a counter anion. The “metal salt” is an ionic compound formed by the metal cation and the counter anion. The term “metal hydroxy salt,” as used herein, may be represented as “M(OH)X” where M is the metal ion, OH is the hydroxy ion, and X is the counter anion. The “metal hydroxy salt” is an ionic compound formed by the metal cation, the hydroxy ion, and the counter anion. The metal ion or the metal cation has been described herein. Examples of the counter anion (X) in the metal salt or the metal hydroxy salt include, but are not limited to: a halide ion, a sulfate ion, a phosphate ion, or equivalents thereof. A “halide” as used herein, includes a chloride ion (Cl⁻), a bromide ion (Br⁻), a fluoride ion (F⁻), or an iodide ion (I⁻).

In some examples, the anode electrolyte comprises both the metal salt comprising the metal ion in the lower oxidation state (e.g., as part of the feedstock that forms the anode electrolyte solution) and the metal hydroxy salt with the metal ion in the higher oxidation state (e.g., formed after oxidation at the anode).

The use of the metal salt as a redox metal (e.g., going from the lower oxidation state to the higher oxidation state and vice versa), as described herein, may lower the operating cell voltage even if the half-cell voltage is above that for the oxygen generation. Typically, oxygen generation at the anode in the same cell where hydrogen gas is being generated at the cathode may require an over-potential at the anode beyond the theoretical minimum in order to generate the molecular oxygen at reasonable current densities. Therefore, reducing the required over-potential in the aspects provided herein, related to the oxidation of the metal salt at the anode, can lower the operating voltage even if the theoretical voltage is slightly higher.

The formation of the metal hydroxy salt with the metal ion in the higher oxidation state from the metal salt with the metal ion in the lower oxidation state may also be a non-catalytic electron transfer step, e.g., the oxidation of the metal ion of the metal salt. The oxidized metal salt, e.g., in the form of the metal hydroxy salt, is transported outside of the cell where oxygen gas can then be liberated from the metal hydroxy salt using heat (the thermal reaction) so that the required energy for oxygen gas formation can be provided thermally. As noted above, this type of change in half-cell reaction to form the metal hydroxy salt can result in a lower operating voltage even if the fundamental half-cell potential is higher because of savings on the over-potential.

The oxidation of the metal salt from the lower to the higher oxidation state, i.e., in the form of the metal hydroxy salt, can further reduce the operating voltage by reducing thermo-neutral voltage. Typically, if heat is supplied from a source other than resistive losses in the cell, the cell can operate at lower voltages. However, resistive losses that add heat into the cell may not be considered as losses until the cell voltage exceeds the thermoneutral voltage. By oxidizing the metal salt at the anode to form the metal hydroxy salt, it may he possible to lower the operating voltage by reducing the thermoneutral voltage. For example, oxidizing the metal salt at the anode to form the metal hydroxy salt can lower the overall voltage by lowering the thermoneutral voltage below about 1.48 V. The lower thermoneutral voltage, as described herein, can be used to lower the overall operating voltage of the electrochemical cell.

The reduction of the operating voltage may also be the result of a lower half-cell potential than what would be required for oxygen evolution at the anode or for hydrogen evolution at the cathode. Because the Gibbs Free Energy may include minimum external work required to accomplish a given transformation (e.g., conversion of water into hydrogen and oxygen), operation below the thermodynamic minimum voltage may be possible if additional energy is provided into the system either as work or as heat. If the heat is obtained from a source other than resistive losses (these losses may include, but not limited to, the losses within the membrane, conductive resistances, solution resistances, and electrode overpotentials) within the cell, the net effect will be a reduced demand in electric power.

Accordingly, in some examples, no oxygen gas is formed at the anode. In another example, less than 25% of the Faradaic efficiency of the electrochemical cell is for the oxygen evolution reaction at the anode.

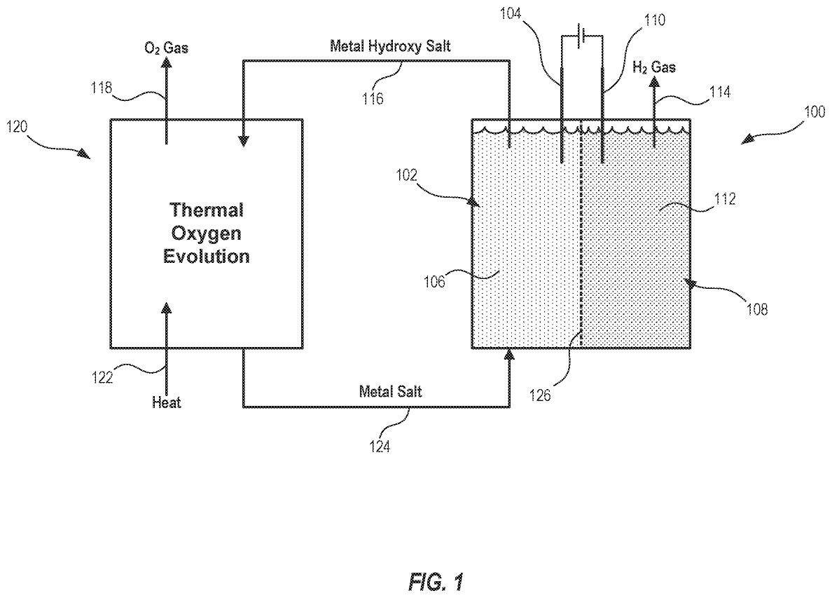

FIGS. 1-5 illustrate various examples of the aspects summarized above. FIG. 1 shows an example system for producing hydrogen gas comprising an electrochemical 100 with an anode chamber 102 containing an anode 104 and an anode electrolyte 106. The anode electrolyte 106 comprises a metal salt with a metal ion in a lower oxidation state, as described in more detail below. The electrochemical cell 100 also includes a cathode chamber 108 containing a cathode 110 and a cathode electrolyte 112. At the anode 104, the metal salt with the metal ion in the lower oxidation state is oxidized to form a metal hydroxy salt with the metal ion in a higher oxidation state. Hydrogen gas 114 is formed at the cathode 110. At least a portion of the anode electrolyte 106 comprising the metal hydroxy salt with the metal ion in the higher oxidation state is transferred outside the electrochemical cell 100, e.g., as an anode electrolyte solution 116 so that the metal hydroxy salt with the metal ion in the higher oxidation state can be subjected to a thermal reaction (e.g., in a thermal reactor) or a second electrochemical process (e.g., in a second electrochemical cell. Either the thermal reaction or the second electrochemical process results in evolution of oxygen gas 118 and reduction of the metal hydroxy salt with the metal ion in the higher oxidation state, reforming the metal salt with the metal ion in the lower oxidation state. The example system shown in FIG. 1 includes a thermal reactor 120, which receives the anode electrolyte solution 116 from the electrochemical cell 100 and applies heat 122 to subject the metal hydroxy salt to the thermal reaction to reduce the metal hydroxy salt with the metal ion in the higher oxidation state to the metal salt with the metal ion in the lower oxidation state. At least a portion of the metal salt with the metal ion in the lower oxidation state may be transferred back to the anode chamber 102 of the electrochemical cell 100, e.g., as an electrolyte solution 124. The water formed in the thermal reaction at the thermal reactor 120 may he partially or fully transferred to the cathode chamber of the cell (not shown in the figures). A membrane 126 or other separator can be positioned between the anode chamber 102 and the cathode chamber 108 of the electrochemical cell 100 to separate the anode 104 from the cathode 110. In some examples, described in more detail below, the membrane 126 can comprise an anion exchange membrane (AEM) or a cation exchange membrane (CEM).

In some examples, the metal hydroxy salt may be formed at the anode 104 under alkaline or acidic conditions.

### Alkaline Conditions

In some examples, the cathode electrolyte 112 comprises water, and the formation of the hydrogen gas 114 at the cathode 110 forms hydroxide ions in the cathode electrolyte and the hydrogen gas. In such examples, the hydroxide ions can be transported from the cathode electrolyte to the anode electrolyte, such as through an anion exchange membrane located between the anode electrolyte and the cathode electrolyte. At least a portion of the hydroxide ions can be transferred out of the electrochemical cell to the thermal reaction process or the second electrochemical process.

Accordingly, in one aspect, a method to generate hydrogen gas comprises:
providing an anode and an anode electrolyte comprising a metal salt in an electrochemical cell;
oxidizing a metal ion of the metal salt from a lower oxidation state to a higher oxidation state at the anode to form a metal hydroxy salt;
providing a cathode and a cathode electrolyte comprising water in the electrochemical cell;
reducing water at the cathode to form hydroxide ions and hydrogen gas;
transporting or migrating the hydroxide ions from the cathode electrolyte to the anode electrolyte;
wherein the metal hydroxy salt with the metal ion in the higher oxidation state is formed from the metal salt and the hydroxide ions in the anode electrolyte;
transferring at least a portion of the anode electrolyte comprising the metal hydroxy salt outside the electrochemical cell; and
subjecting the portion of the anode electrolyte comprising the metal hydroxy salt to thermal reaction to form oxygen gas and the metal salt.

In one aspect, a system to generate hydrogen gas comprises:
an electrochemical cell comprising;
   an anode and an anode electrolyte comprising a metal salt with a metal ion in a lower oxidation state, wherein the anode is configured to oxidize the metal salt with the metal ion in the lower oxidation state to a metal hydroxy salt with the metal ion in a higher oxidation state;
   a cathode and a cathode electrolyte comprising water, wherein the cathode is configured to reduce water to form hydroxide ions and hydrogen gas; and
   an anion exchange membrane configured to transport hydroxide ions from the cathode electrolyte to the anode electrolyte;
   wherein the metal hydroxy salt with the metal ion in the higher oxidation state is formed at the anode from the metal salt and the hydroxide ions in the anode electrolyte; and
a thermal reactor operably connected to the electrochemical cell, wherein the thermal reactor is configured to receive at least a portion of the anode electrolyte comprising the metal hydroxy salt and subject the portion of the anode electrolyte to a thermal reaction to form oxygen gas and the metal salt with the metal ion in the lower oxidation state.

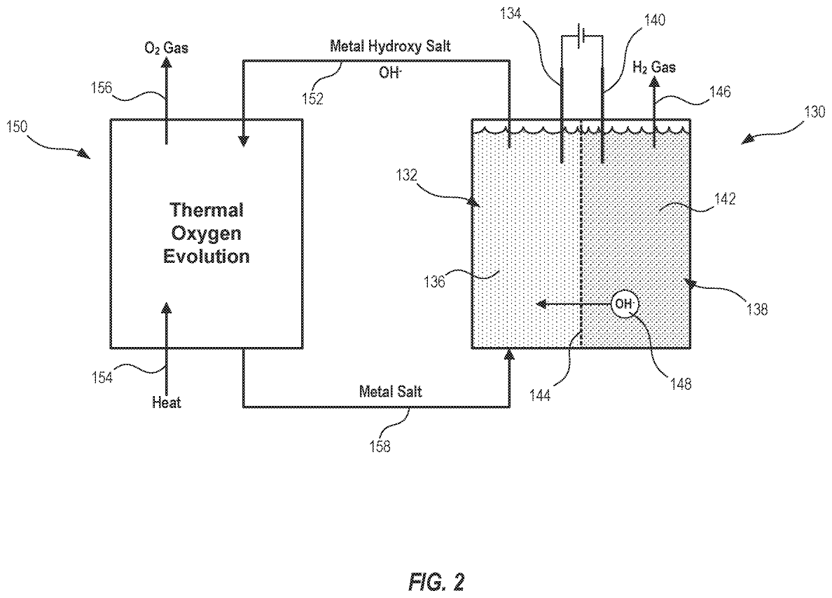

FIG. 2 illustrates a system that incorporates these aspects. As can be seen in FIG. 2, the system includes an electrochemical call 130 that is essentially identical to the electrochemical cell 100 in FIG. 1, wherein the electrochemical cell 130 comprises an anode chamber 132 containing an anode 134 and an anode electrolyte 136 comprising the metal salt with the metal ion in the lower oxidation state, a cathode chamber 138 containing a cathode 140 and a cathode electrolyte 142. As in the system of FIG. 1, the anode 134 oxidizes the metal ion of the metal salt from the lower oxidation state to the higher oxidation state in order to form the metal hydroxy salt. In some examples, the anode electrolyte 136 comprises the metal salt and water or in some examples, the anode electrolyte 136 comprises the metal salt and salt water (further described herein). In some examples, the presence of the salt (described further herein) may solubilize the metal salt in the anode electrolyte 136, which can result in improved efficiency of the process. In some examples, the presence of the salt during the thermal reaction may facilitate the evolution of the oxygen gas.

The anode chamber 132 and the cathode chamber 138 in the electrochemical cell 130 of FIG. 2 are separated by an anion exchange membrane (AEM) 144, rather than a PEM. The use of the AEM 144 reduces or minimizes the transport of the metal ions from the anode chamber 132 to the cathode chamber 138, which reduces or minimizes contamination of the cathode electrolyte 142 and can improve the efficiency of the process. The cathode electrolyte 142 may comprise water and the cathode 110 reduces the water to form hydrogen gas 146 and hydroxide ions 148. The hydroxide ions 148 transfer or migrate through the AEM 144 from the cathode electrolyte 142 into the anode electrolyte 136. The hydroxide ions 148 may then combine with the metal salt with the metal ion in the lower oxidation state to form the metal hydroxy salt with the metal ion in the higher oxidation state. At least a portion of the anode electrolyte comprising the metal hydroxy salt can be transferred outside the electrochemical cell 130 to a thermal reactor 150, such as with an anode electrolyte solution 152. In the thermal reactor 150, heat 154 is applied to the metal hydroxy salt to subject it to a thermal reaction, which results in the evolution of oxygen gas 156 and reduction of the metal hydroxy salt to form the metal salt with the metal ion in the lower oxidation state. At least a portion of this metal salt may be transferred back to the anode chamber 132 of the electrochemical cell 130, such as via an electrolyte solution 158. The anode electrolyte solution 152 that transfers the metal hydroxy salt from the anode chamber 132 to the thermal reactor 150 may be in solid form or in a liquid solution form. In some examples, the metal hydroxy salt may be partially or fully insoluble in the anode electrolyte 136. In such examples, the metal hydroxy salt may or may not be separated from the anode electrolyte 136. Various known techniques can be used for the separation including, but not limited to, techniques for liquid-solid separation, e.g., filtration.

In some examples, the pH of the anode electrolyte 136 can affect oxidation of the metal salt and/or the oxidation of the hydroxy ions 148 to form oxygen gas (described later herein), over any other competing oxidation reaction. In some examples, the pH of the anode electrolyte 136 is more than about 5, for example more than about 6, such as more than about 7, for example more than about 8. such as more than about 9, for example more than about 10, such as from about 5 to about 15, for example from about 5 to about 10, such as from about 9 to about 15, for example from about 9 to about 14, such as from about 9 to about 13, for example from about 9 to about 12, such as from about 9 to about 11, for example from about 9 to about 10, such as from about 10 to about 12, for example from about 10 to about 14, such as from about 10 to about 11.5, for example from about 11 to about 15, for example equal to or substantially equal to 9, such as equal to or substantially equal to 10, for example equal to or substantially equal to 11, such as equal to or substantially equal to 11.5. In some examples, the pH of the anode electrolyte 136 may facilitate oxidation of the metal salt over the oxidation of the hydroxide ions migrating from the cathode electrolyte 142 to the anode electrolyte 136. In some examples, the method further comprises maintaining a steady-state pH differential of greater than 1 between the anode electrolyte 136 and the cathode electrolyte 142, for example a pH differential of from about 1 to about 6.

The methods and systems provided herein are sometimes closed-loop processes, therefore, the order of one or more steps provided herein may be alternated or rearranged and the steps are not necessarily arranged in a serial fashion.

The metal ion in the metal salt in any of the systems or methods described herein can be any compatable redox metal. In some examples, the metal salt with the metal ion in the lower oxidation state enters the anode chamber 132 of the electrochemical cell 130 where the metal ion of the metal salt is oxidized to a higher oxidation state at the anode. The metal salt with the metal ion in the higher oxidation state may combine with one or more of the hydroxide ions 148 to form a metal hydroxy salt having the metal ion in the higher oxidation state, which can occur in accordance with the change in the oxidation state as shown in the half-cell reactions below:

Anode Reaction: Mⁿ⁺+(m−n)OH⁻→M^{m+}(m−n)OH⁻+(m−n)e⁻

Cathode Reaction: (m−n)e⁻+(m−n)H₂O→((m−n)/2)H₂+(m−n)OH⁻

In the above noted reactions, the metal ion of the metal salt in the lower oxidation state is represented as Mⁿ⁺ and the metal ion of the metal salt in the higher oxidation state is represented as M^{m+}. The metal hydroxy salt, M^{m+}(m−n)OH⁻, then undergoes thermal reaction to form oxygen gas as in the thermal reaction below:

Thermal reaction: M^{m+}(m−n)OH⁻→Mⁿ⁺+((m−n)/4)O₂+((m−n)/2)H₂O

It is to be understood that the metal hydroxy salt in the methods and systems provided herein may be one or more species of stoichiometry Mₓ^{m+}X_{y}(OH)_{(Mx-y)}, MₓX_{y}(OH)_{(2x-y)}, MₓX_{y}(OH)_{(3x-y)} or MₓX_{y}(OH)_{(4x-y)}, where M is the metal ion, X is a counter anion, and m, x, and y are integers. In some examples, m, x, and y are integers from 1 to 5. For example, the CuBrOH species represents one of many possible copper hydroxy bromide species of stoichiometry CuₓBr_{y}(OH)_{(2x-y)}. Other examples of the metal hydroxy salt, without limitation include, MX(OH)₃, MX₂(OH)₂, and MX₃(OH) (where M is the metal and X is the counter anion).

An illustrative example of the metal ion of the metal salt is copper. In some examples, when the metal salt is a copper salt, the reactions can be illustrated as below:

Anode Reaction: 4CuX+4OH⁻43 4CuXOH+4e⁻

Cathode Reaction: 4e⁻+4H₂O→2H₂+4OH⁻

Thermal reaction: 4CuXOH→4CuX+O₂+2H₂O

In some examples, the counter anion X is a halide ion, a sulfate ion, or a phosphate ion. Examples of halide ions include a fluoride ion (F⁻), a bromide ion (Br⁻), a chloride ion (Cl⁻). or an iodide ion (I⁻). For example, the metal hydroxy salt CuXOH in the above reactions may be copper hydroxy chloride (CuClOH), copper hydroxy bromide (CuBrOH), or copper hydroxy iodide (CuIOH).

In some examples, the thermal reactor/reaction to generate the oxygen gas may be replaced or may be run simultaneously with a second electrochemical cell/reaction.

In one aspect, a method to generate hydrogen gas comprises:
providing a first anode and a first anode electrolyte in a first electrochemical cell, wherein the first anode electrolyte comprises a metal salt;
oxidizing the metal salt to a metal hydroxy salt at the first anode;
providing a first cathode and a first cathode electrolyte in the first electrochemical cell;
forming hydrogen gas and hydroxide ions at the first cathode;
transferring at least a portion of the first anode electrolyte comprising the metal hydroxy salt outside the first electrochemical cell to a second cathode electrolyte of a second electrochemical cell;
reducing the metal hydroxy salt to the metal salt at a second cathode of the second electrochemical cell; and
migrating hydroxide ions from the second cathode electrolyte to a second anode electrolyte through a second AEM in the second electrochemical cell; and
oxidizing the hydroxide ions at a second anode in the second electrochemical cell to form oxygen gas.

In some examples, the method further comprises transferring the hydroxide ions from the first cathode electrolyte to the first anode electrolyte through a first AEM in the first electrochemical cell. In some examples, the method further comprises transferring at least a portion of the second cathode electrolyte of the second electrochemical cell (comprising the metal salt) back to the first anode electrolyte of the first electrochemical cell.

In one aspect, a system to generate hydrogen gas comprises:
a first electrochemical cell comprising;
   a first anode and a first anode electrolyte comprising a metal salt, wherein the first anode is configured to oxidize the metal salt to a metal hydroxy salt; and
   a first cathode and a first cathode electrolyte comprising water, wherein the first cathode is configured to reduce water to form hydroxide ions and hydrogen gas; and
a second electrochemical cell operably connected to the first electrochemical cell, the second electrochemical cell comprising;
   a second anode and a second anode electrolyte;
   a second cathode and a second cathode electrolyte, wherein the second cathode electrolyte is configured to receive at least a portion of the first anode electrolyte of the first electrochemical cell comprising the metal hydroxy salt, and
wherein the second cathode is configured to reduce the metal hydroxy salt to the metal salt,

In some examples, the aforementioned system further comprises a first AEM between the first anode and the first cathode of the first electrochemical cell. In some examples, the system further comprises a second AEM between the second anode and the second cathode of the second electrochemical cell. In some examples, the system includes a first AEM between the first anode and the first cathode in the first electrochemical cell and a second AEM between the second anode and the second cathode in the second electrochemical cell. Each AEM can be configured to transfer hydroxide ions from the corresponding cathode electrolyte to the corresponding anode electrolyte through the AEM. In some examples, the second anode in the second electrochemical cell is configured to oxidize hydroxide ions to form oxygen gas,

In some examples, the first electrochemical cell and the second electrochemical cell operate at different currents and different voltages to selectively perform their respective anode reactions.

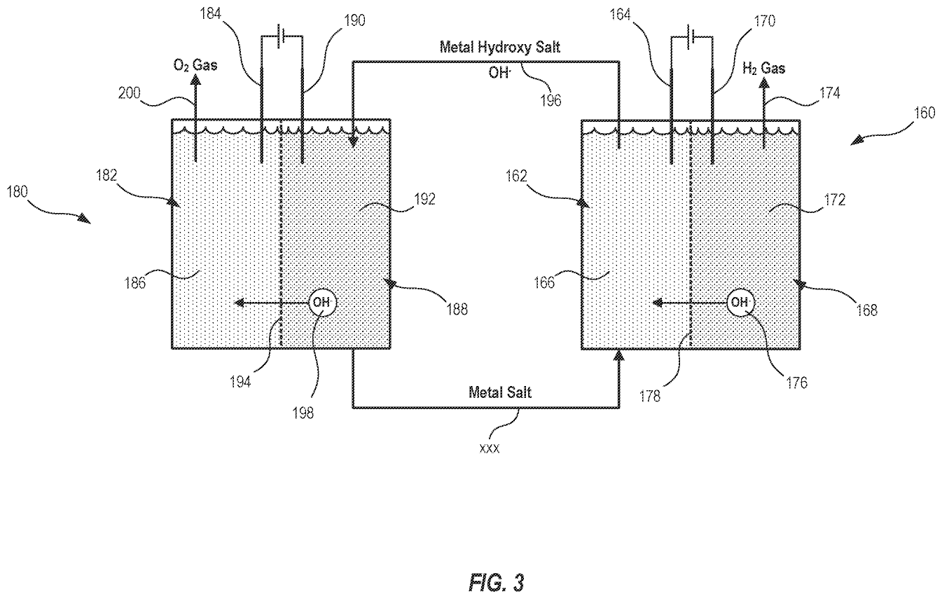

FIG. 3 illustrates a system that incorporates the two electrochemical cells described with respect to the foregoing aspects. As can be seen in FIG. 3, the system includes a first electrochemical cell 160 comprising a first anode chamber 162 that contains a first anode 164 and a first anode electrolyte 166. As with the prior anode electrolytes 106, 136 described above, the first anode electrolyte 166 comprises a metal salt with a metal ion in a lower oxidation state, which can be oxidized at the first anode 164 to form a metal hydroxy salt with the metal ion in a higher oxidation state. The first electrochemical cell 160 also includes a first cathode chamber 168 that contains a first cathode 170 and a first cathode electrolyte 172. The first cathode electrolyte 172 can comprise water that is reduced at the first cathode 170 to generate hydrogen gas 174 and hydroxide ions 176. A first anion exchange membrane (AEM) 178 located between the anode chamber 162 and the cathode chamber 168 to separate the first anode electrolyte 166 from the first cathode electrolyte 172. The first AEM 178 can transfer or migrate the hydroxide ions 176 from the first cathode electrolyte 172 to the first anode electrolyte 162.

The system of FIG. 3 also includes a second electrochemical cell 180 that is structurally similar or identical to the first electrochemical cell 160, e.g., with the second anode chamber 182 that contains a second anode 184 and a second anode electrolyte 186, a second cathode chamber 188 that contains a second cathode 190 and a second cathode electrolyte 192, and a second anion exchange membrane (AEM) 194 located between the second anode chamber 182 and the second cathode chamber 188 to separate the second anode electrolyte 186 from the second cathode electrolyte 192.

In some examples, at least a portion of the first anode electrolyte 166 comprising the metal hydroxy salt is transferred outside the first electrochemical cell 160, for example as an anode electrolyte solution 196, and is added to the second cathode electrolyte 192 of the second electrochemical cell 180. In the second electrochemical cell 180, the metal hydroxy salt (e.g., with the metal ion in the higher oxidation state) is reduced to the metal salt (e.g., with the metal ion in the lower oxidation state) at the second cathode 190. Hydroxide ions 198 that are formed from this reduction of the metal hydroxy salt to the metal salt can migrate from the second cathode electrolyte 192 to the second anode electrolyte 186 through the second AEM 194. The second anode 184 oxidizes the hydroxide ions 198 to form oxygen gas 200. At least a portion of the second cathode electrolyte 192 from the second electrochemical cell 180, which includes the metal salt that was formed by the reduction of the metal hydroxy salt at the second cathode 190, can be transferred back to the first anode chamber 162 of the first electrochemical cell 160 and combined with the first anode electrolyte 166, e.g., such that the reformed metal salt with the metal ion in the lower oxidation state can be oxidized at the first anode 164 to form the metal hydroxy salt.

Applicants have found unique methods and systems whereby maintaining a steady-state pH differential between the anode electrolyte and the cathode electrolyte, e.g., increasing the pH of the anode electrolyte and/or decreasing the pH of the cathode electrolyte, the sum of the reactions at the anode and the cathode can result in a theoretical potential of less than about 1.23 V.

The methods and systems described herein include alkaline water electrolysis employing a membrane, such as the anion exchange membrane (AEM) to separate the two electrode chambers, each of which uses alkaline electrolytes, such as but not limited to, NaOH or KOH. In some examples, the cathode electrolyte may be at a relatively low pH and the anode electrolyte can be at a relatively high pH. Both the anode electrolyte and the pH of the cathode electrolyte can be maintained at their respective pH via thermal means for water balance. The theoretical voltage for the entire water electrolysis reaction can be 1.23−0.059*ΔpH volts, where ΔpH is the pH difference between the anode electrolyte and the cathode electrolyte. For example, an anode electrolyte pH of 15 and a cathode electrolyte pH of 11 would have a theoretical water electrolysis potential of about 0.994 V, or about 0.236 V less than the 1.23 V theoretical potential.

In one aspect, a method to generate hydrogen gas comprises:
providing an anode and an anode electrolyte in an electrochemical cell, wherein the anode electrolyte comprises a metal salt;
oxidizing the metal salt to a metal hydroxy salt at the anode;
providing a cathode and a cathode electrolyte in the electrochemical cell;
forming hydrogen gas and hydroxide ions at the cathode;
separating the anode electrolyte from the cathode electrolyte by an anion exchange membrane (ARM);
migrating the hydroxide ions from the cathode electrolyte to the anode electrolyte through the AEM; and
maintaining a steady-state pH differential of greater than 1 between the anode electrolyte and the cathode electrolyte.

In some examples, the method further comprises operating the electrochemical cell at a theoretical voltage of less than about 1.23 V.

In one aspect, an electrochemical cell to generate hydrogen gas comprises:
an anode and an anode electrolyte comprising a metal salt, wherein the anode is configured to oxidize the metal salt to a metal hydroxy salt;
a cathode and a cathode electrolyte comprising water, wherein the cathode is configured to reduce water to form hydroxide ions and hydrogen gas; and
an anion exchange membrane disposed between the anode electrolyte and the cathode electrolyte, wherein the anion exchange membrane is configured to migrate the hydroxide ions from the cathode electrolyte to the anode electrolyte;
wherein the electrochemical cell is configured to maintain a steady-state pH differential of greater than 1 between the anode electrolyte and the cathode electrolyte.

In some examples, the electrochemical cell system is configured to operate at a theoretical voltage of less than about 1.23 V.

In some examples, the pH of the cathode electrolyte is lower than the pH of the anode electrolyte. In some examples, the pH of the anode electrolyte is from about 10 to about 15 and the pH of the cathode electrolyte is from about 8 to about 13. In some examples, the pH of the anode electrolyte is from about 10 to about 15 and the pH of the cathode electrolyte is from about 8 to about 13 while maintaining a steady-state pH differential of greater than 1 between the anode electrolyte and the cathode electrolyte.

In some examples, the pH of the anode electrolyte is from about 10 to about 15, for example from about 10 to about 14, such as from about 10 to about 13, for example from about 10 to about 12, such as from about 10 to about 11, for example from about 11 to about 15, such as from about 11 to about 14, for example from about 11 to about 13, such as from about 11 to about 12, for example from about 12 to about 15, such as from about 12 to about 14, for example from about 12 to about 13, such as from about 13 to about 15, for example from about 13 to about 14, such as from about 14 to about 15.

In some examples, the pH of the cathode electrolyte is from about 8 to about 13, for example from about 8 to about 12, such as from about 8 to about 11, for example from about 8 to about 10, such as from about 8 to about 9, for example from about 9 to about 13, such as from about 9 to about 12, for example from about 9 to about 11, such as from about 9 to about 10; between about 10 to about 13, for example from about 10 to about 12, such as from about 10 to about 11; for example from about 11 to about 13 such as from about 11 to about 12 for example from about 12 to about 13.

In some examples, the pH of the anode electrolyte is from about 10 to about 15, for example from about 10 to about 14, such as from about 10 to about 13, for example from about 10 to about 12, such as from about 10 to about 11; and the pH of the cathode electrolyte is from about 8 to about 13, for example from about 8 to about 12, such as from about 8 to about 11, for example from about 8 to about 10, such as from about 8 to about 9. In some examples, the pH of the anode electrolyte is from about 10 to about 15, for example from about 10 to about 14, such as from about 10 to about 13, for example from about 10 to about 12, such as from about 10 to about 11; the pH of the cathode electrolyte is from about 8 to about 13, for example from about 8 to about 12, such as from about 8 to about 11, for example from about 8 to about 10, such as from about 8 to about 9; and the steady-state pH differential between the anode electrolyte and the cathode electrolyte is from about 1 to about 6, for example from about 1 to about 5, such as from about I to about 4, for example from about 1 to about 3, such as from about 1 to about 2.

In some examples, the pH of the anode electrolyte is from about 12 to about 15, for example from about 12 to about 14, such as from about 12 to about 13, for example from about 13 to about 15, such as from about 13 to about 14, for example from about 14 to about 15; and the pH of the cathode electrolyte is from about 11 to about 13, for example from about 11 to about 12, such as from about 12 to about 13.

In some examples, the steady-state pH differential between the anode electrolyte and the cathode electrolyte is greater than 1, for example from about 1 to about 7, such as from about 1 to about 6, for example from about 1 to about 5, such as from about 1 to about 4, for example from about 1 to about 3, such as from about 1 to about 2, for example from about 2 to about 7, such as from about 2 to about 6, for example from about 2 to about 5, such as from about 2 to about 4. for example from about 2 to about 3, such as from about 3 to about 7, for example from about 3 to about 6, such as from about 3 to about 5, for example from about 3 to about 4, such as from about 4 to about 7, for example from about 4 to about 6, such as from about 4 to about 5, for example from about 5 to about 7, such as from about 5 to about 6, for example from about 6 to about 7.

The pH of the cathode electrolyte and the anode electrolyte can be maintained via thermal means for water balance. In some examples, the water being added to the cathode chamber can be from an external feedstock and/or recirculated from the anode chamber. In some examples, at least a portion of the water may be removed thermally internally or externally from the anode chamber of the electrochemical cell and transferred to the cathode chamber. Means for such transfer are well known in the art and include without limitation conduits, pipes, and/or tanks for the storage and/or transfer.

In some examples, the balance between the electrical conductivity of the cathode electrolyte and its pH is maintained such that the pH of the cathode electrolyte is lower than that of the anode electrolyte and such that the cathode electrolyte has an electrical conductivity that does not adversely affect the cell voltage owing to a large resistance.

In some examples, the methods and the systems provided herein further comprise a salt comprising polyatomic anion in the cathode electrolyte. The term “polyatomic anion in the salt,” as used herein, refers to a covalently bonded set of two or more atoms that has a net charge that is not zero. Examples of the polyatomic anion in the salt can include, but are not limited to: a carbonate, a citrate, an oxalate, ethylene diamine tetraacetic acid (EDTA), a malate, an acetate, a phosphate, a sulfate, or combinations thereof. In some examples, the counter cation in the salt comprising the polyatomic anion is selected from the group consisting of: lithium, sodium, potassium, and combinations thereof. It is to be understood that the “polyatomic anion in the salt” in the cathode electrolyte is different from the “metal salt” in the anode electrolyte or any other “salt” or “salt water” in the electrolytes described herein.

In some examples, the salt comprising one or more cations and a polyatomic anion is selected such that the salt is stable and soluble in alkaline (e.g., pH>7) conditions and possesses one or more properties, such as, but not limited to, not blocking the membrane transport mechanism, not migrating through the membrane, not reacting at the cathode, and/or not reacting with hydroxide, hydrogen, or oxygen. In some examples, the polyatomic anion is such that the polyatomic anion is selectively rejected by the AEM so that only hydroxide ions are transported across the AEM from the cathode chamber to the anode chamber to maintain the pH differential. In some examples, the polyatomic anion may also be selected such that the polyatomic anion is stable in a reducing environment so that water is reduced at the cathode instead of the polyatomic anion. In some examples, the corresponding cation in the salt are selected such that the cation does not diffuse through the membrane from the cathode chamber to the anode chamber and is not reduced at the cathode.

In some examples, the concentration of the salt comprising the polyatomic anion in the cathode electrolyte is from about 0.1 M to about 3 M, for example from about 0.1 M to about 2.5 M, such as from about 0.1 M to about 2 M, for example from about 0.1 M to about 1.5 M, such as from about 0.1 M to about 1 M, for example from about 0.1 NI to about 0.5 M, such as from about 0.5 M to about 3 M, for example from about 0.5 M to about 2.5 M, such as from about 0.5 M to about 2 M, for example from about 0.5 M to about 1.5 M, such as from about 0.5 M to about 1 M, for example from about 1 M to about 3 M, such as from about 1 M to about 2.5 M, for example from about 1 M to about 2 M, such as from about 1 M to about 1.5 M, for example from about 1.5 M to about 3 M, such as from about 1.5 M to about 2.5 M, for example from about 1.5 M to about 2 M, such as from about 2 M to about 3 M, for example from about 2 M to about 2.5 M.

In some examples, the methods and systems have a theoretical voltage of less than 1.3 V, or less than 1.5 V, or less than 2 V, or less than 2.5 V of the electrochemical cell. In some examples, the methods and systems have an operating voltage of between 1.3 V to about 3 V, or between 1.5 V to about 3 V, or between 2 V to about 3 V, or between 1 V to about 3 V, or between 1.5 V to about 2.5 V, of the electrochemical cell.

### Acidic Conditions

In one aspect, a method to generate hydrogen gas comprises:
providing a first anode and a first anode electrolyte comprising a metal salt and water in a first electrochemical cell;
oxidizing a metal ion of the metal salt from a lower oxidation state to a higher oxidation state at the first anode to form a metal hydroxy salt and hydrogen ions;
providing a first cathode and a first cathode electrolyte in the first electrochemical cell;
transporting hydrogen ions from the first anode electrolyte to the first cathode electrolyte;
reducing hydrogen ions at the first cathode to form hydrogen gas;
transferring at least a portion of the first anode electrolyte comprising the metal hydroxy salt outside the first electrochemical cell; and
subjecting the portion of the first anode electrolyte comprising the metal hydroxy salt to a thermal reaction or to a second electrochemical cell to form oxygen gas.

In one aspect, a system to generate hydrogen gas comprises:
an electrochemical cell comprising;
   an anode and an anode electrolyte comprising a metal salt with a metal ion in a lower oxidation state and water, wherein the anode is configured to oxidize the metal salt with the metal ion in the lower oxidation state to a metal hydroxy salt with the metal ion in a higher oxidation state and to form hydrogen ions;
   a cathode and a cathode electrolyte, wherein the cathode is configured to reduce the hydrogen ions to form hydrogen gas; and
   a cation exchange membrane configured between the anode and the cathode, wherein the cation exchange membrane is configured to transport the hydrogen ions from the anode electrolyte to cathode electrolyte;
a thermal reactor operably connected to the electrochemical cell and configured to receive at least a portion of the anode electrolyte comprising the metal hydroxy salt and subject the portion of the anode electrolyte to a thermal reaction to form oxygen gas and the metal salt with the metal ion in the lower oxidation state.

In one aspect, a system to generate hydrogen gas comprises:
a first electrochemical cell comprising;
   a first anode and a first anode electrolyte comprising a metal salt with a metal ion in a lower oxidation state and water, wherein the first anode is configured to oxidize the metal salt with the metal ion in the lower oxidation state to a metal hydroxy salt with the metal ion in a higher oxidation state and to form hydrogen ions;
   a first cathode and a first cathode electrolyte, wherein the first cathode is configured to reduce the hydrogen ions to form hydrogen gas; and
   a first cation exchange membrane between the first anode and the first cathode, wherein the first cation exchange membrane is configured to transport the hydrogen ions from the first anode electrolyte to first cathode electrolyte;
a second electrochemical cell operably connected to the first electrochemical cell, the second electrochemical cell comprising;
   a second anode and a second anode electrolyte;
   a second cathode and a second cathode electrolyte, wherein the second cathode electrolyte is configured to receive at least a portion of the first anode electrolyte of the first electrochemical cell comprising the metal hydroxy salt, and wherein the second cathode is configured to reduce the metal hydroxy salt to the metal salt.

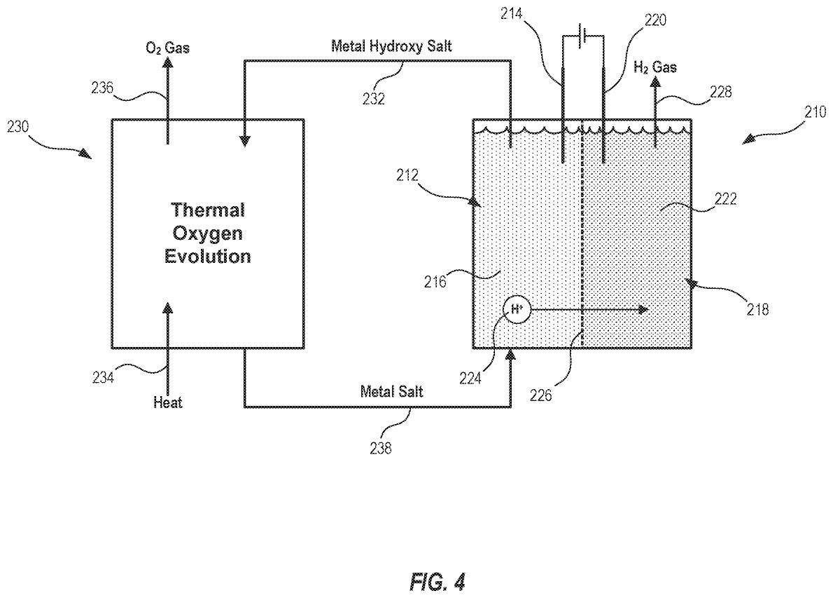

FIG. 4 illustrates a system for operating in acidic conditions. The system includes an electrochemical cell 210 that is similar to the electrochemical cells 100, 130, 160 described above, e.g., comprising an anode chamber 212 that contains an anode 214 and an anode electrolyte 216 that comprises a metal salt with a metal ion in a lower oxidation state and water. The electrochemical cell 210 also includes a cathode chamber 218 that contains a cathode 220 and a cathode electrolyte 222. Similar to the cells described above, the anode 214 oxidizes the metal ion of the metal salt from a lower oxidation state to a higher oxidation state to form a metal hydroxy salt. However, unlike the cells described above, the anode 214 of the electrochemical cell 210 in FIG. 3 also oxidizes the water in the anode electrolyte 216 to form hydrogen ions 224.

In some examples, the anode electrolyte 216 further comprises a salt (further described herein). In some examples, the presence of the salt (described further herein) can solubilize the metal salt in the anode electrolyte 216, which can improve efficiency of the electrochemical cell 210 and/or may improve the efficiency of the thermal process.

Another difference in the electrochemical cell 210 of FIG. 3 from the cells described earlier is that the anode chamber 212 and the cathode chamber 218 of the electrochemical cell 210 are separated by a cation exchange membrane (CEM) 226 rather than an anion exchange membrane (AEM) in order to reduce or minimize or eliminate the transport of the metal ion from the anode chamber 212 to the cathode chamber 218 and reduce, minimize, or prevent contamination of the cathode electrolyte 222 and improve the efficiency of the electrochemical cell 210.

The hydrogen ions 224 transfer or migrate through the CEM 226 from the anode electrolyte 216 into the cathode electrolyte 222 where is the hydrogen ions 224 are reduced at the cathode 220 to form hydrogen gas 228. At least a portion of the anode electrolyte 216 comprising the metal hydroxy salt is transferred outside the electrochemical cell 210 to a thermal reactor 230, such as with an anode electrolyte solution 232. In the thermal reactor 230, the metal hydroxy salt is subjected to a thermal reaction by the application of heat 234, which results in the evolution of oxygen gas 236 and reduction of the metal hydroxy salt with the metal ion in the higher oxidation state back to the metal salt with the metal ion in the lower oxidation state. Alternatively, the portion of the anode electrolyte 216 can be transferred to a second electrochemical cell (not shown, but similar to the system as illustrated in FIG. 3), where the metal hydroxy salt can be electrochemically reduced to the metal salt and the oxygen gas can be electrochemically generated. At least a portion of the reformed metal salt with the metal ion in the lower oxidation state can be transferred back to the anode chamber 212 of the electrochemical cell 210, such as via an electrolyte solution 238. The electrolyte solution 232 that “transfers” the metal hydroxy salt from the anode chamber 212 to the thermal reactor 230 or the second electrochemical cell may be in a solid or liquid solution form. In some examples, the metal hydroxy salt may be partially or fully insoluble in the anode electrolyte 216. In such examples, the metal hydroxy salt may or may not be separated from the anode electrolyte 216. Various known techniques can be used for the separation including, but not limited to, techniques for liquid-solid separation, e.g., filtration.

The metal ion of the metal salt in the systems and methods described herein can be any redox metal. In some examples, the metal ion in the lower oxidation state enters the anode chamber 216 of the electrochemical cell 210 where it is oxidized to the higher oxidation state at the anode 214 along with the water splitting reaction to form the metal hydroxy salt and the hydrogen ions 224. The hydrogen ions 224 can transfer or migrate to the cathode electrolyte 222 through the CEM 226 where the cathode 220 reduces the hydrogen ions 224 to generate the hydrogen gas 228. The half-cell reactions are given as below:

Anode Reaction: Mⁿ⁺+(m−n)H₂O→M^{m+}(m−n)OH+(m−n)H⁺+(m−n)e⁻

Cathode Reaction: (m−n)e⁻+(m−n)H⁺→((m−n)/2)H₂⁻

In the above noted reactions, the metal ion of the metal salt in the lower oxidation state is represented as Mⁿ⁺ and the metal ion of the metal salt in the higher oxidation state is represented as M^{m+}. The thermal reaction remains the same:

Thermal reaction: M^{m+}(m−n)OH⁻→Mⁿ⁺+((m−n)/4)O₂+((m−n)/2)H₂O

In some examples, the methods and systems have a theoretical voltage of less than about 1:3 V, or less than about 1.5 V, or less than about 2 V, or less than about 2.5 V for the electrochemical cell 210. In some examples, the methods and systems have an operating voltage of between about 1.3-3 V, or between about 1.5-3 V, or between about 2-3 V, or between about 1-3 V, or between about 1.5-2.5 V, for the electrochemical cell 210.

As described in the aforementioned methods and systems, the oxidation of the metal salt at the anode is at a voltage low enough to not evolve gas (e.g., oxygen or chlorine gas) or to evolve minimal amount of gas to prevent efficiency losses in the cell. In such examples, the cell may operate at below about 25% Faradaic efficiency to oxygen (i.e., as low as about 75% of current may be for the oxidation of the metal salt to the metal hydroxy salt and up to only about 25% such as e.g., up to only about 15%, for example up to only about 10%, such as up to only about 5%, for example up to only about 1% may be for the oxygen evolution).

In some examples, the electrochemical cell oxidizing the metal salt at the anode may also be operated in such a way to form oxygen gas at the anode simultaneously, or sequentially, or solely, depending on the applied current or current density and the voltage in the cell. In such examples, the cell may operate at below about 95% Faradaic efficiency to oxygen (i.e., up to about 95% may be for the oxygen evolution).

Typically, electrochemical systems are designed to prevent a secondary reaction at the electrode, to prevent efficiency losses in making an undesirable product. Applicants surprisingly and unexpectedly found that it is economically advantageous to have an electrochemical system with the flexibility to run at variable power to form different products at the anode to align with variable electrical power availability/prices and form the hydrogen gas at the cathode with lower cost. For example, the oxidation of the metal salt at the anode may be predominant at low current and voltage with minimal or no oxygen gas formed at the anode, while the oxidation of hydroxide ions to oxygen gas may be predominant at high current and high voltage with minimal or no metal salt oxidation. The cells may be operated at low current during peak electricity prices (such as e.g., daytime) or load shedding to oxidize the metal salt and the same cells may be operated at the high current or load gaining at the low electricity prices (such as e.g., nighttime or daytime when the power comes from a solar plant) to form the oxygen gas at the anode.

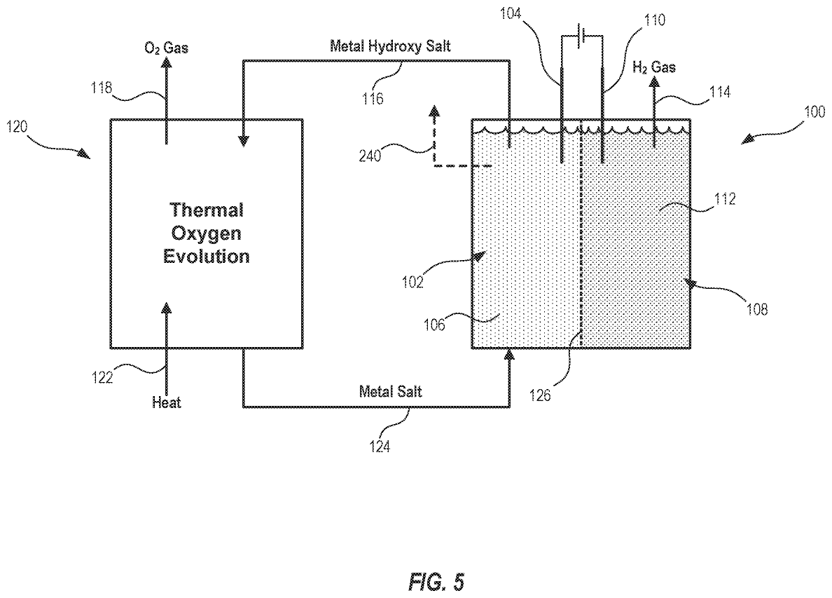

In some examples, select metal salt oxidation occurs at a lower voltage at the anode than oxygen evolution, increasing the efficiency of the hydrogen production (i.e. lower overall voltage) at the cathode. Applicants surprisingly found that in some examples, the metal salt oxidation may not be sustained at higher current due to mass transfer limitations, such that the reactive species may not be replenished at the electrode quick enough. The voltage of the system may increase in order to sustain the desired current and may oxidize the next energetically lowest reactant, such as the hydroxide to the oxygen gas. Therefore, in some examples, the metal salt can be oxidized and the oxygen gas evolved simultaneously (illustrated in the example system shown in FIG. 5, which is substantially identical to the system of FIG. 1, but with the evolution of oxygen gas 240 at the anode 104, which is shown with a dashed arrow) or sequentially, or solely by controlling the current and the voltage. This flexibility in operation can provide an advantage to generate hydrogen at a lower voltage overall and to have the ability to increase hydrogen production when conditions are favorable (such as low electricity prices) by both oxidizing; the metal salt and evolving the oxygen gas at the same anode.

Accordingly, in one aspect, a method to generate hydrogen gas comprises:
providing an anode and an anode electrolyte comprising a metal salt with a metal ion in a lower oxidation state in an electrochemical cell:
oxidizing the metal salt with the metal ion in the lower oxidation state to a metal hydroxy salt with the metal ion in a higher oxidation state at the anode;
oxidizing hydroxide ions at the anode to form oxygen gas;
providing a cathode and a cathode electrolyte in the electrochemical cell; and
forming hydrogen gas at the cathode.

In some examples, at least a portion of the anode electrolyte comprising the metal hydroxy salt is transferred outside the electrochemical cell and is either reduced thermally (e.g., in a thermal reactor) and/or electrochemically (e.g., in a second electrochemical cell) to form oxygen gas and a reduced form of the metal salt. Both the thermal reaction as well as the electrochemical reaction to form the oxygen gas have been described herein (and as illustrated in figures). In some examples, the cathode forms hydroxide ions and the hydroxide ions transfer or migrate from the cathode electrolyte to the anode electrolyte.

In one aspect, a system to generate hydrogen gas comprises:
an electrochemical cell comprising;
   an anode and an anode electrolyte comprising a metal salt with a metal ion in a lower oxidation state, wherein the anode is configured to oxidize the metal salt with the metal ion in the lower oxidation state to a metal hydroxy salt with the metal ion in a higher oxidation state and/or oxidize hydroxide ions to oxygen gas; and
   a cathode and a cathode electrolyte comprising water, wherein the cathode is configured to reduce water to form hydroxide ions and hydrogen gas.

In some examples, the system further comprises a thermal reactor operably connected to the electrochemical cell and configured to receive at least a portion of the anode electrolyte comprising the metal hydroxy salt and subject the portion of the anode electrolyte to a thermal reaction to form oxygen gas and the metal salt.

In some examples, the oxidation of the metal salt is at a lower current density and the oxidation of the hydroxide ions to the oxygen gas is at a higher current density.

In some examples, the hydroxide ions transfer from the cathode electrolyte to the anode electrolyte.

In one aspect, a method to generate hydrogen gas comprises:
providing an anode and an anode electrolyte comprising a metal salt with a metal ion in a lower oxidation state in an electrochemical cell;
oxidizing the metal salt with the metal ion in the lower oxidation state to a metal hydroxy salt with the metal ion in a higher oxidation state at the anode at a current density of from about 1 mA/cm² to about 1000 mA/cm², or from about 1 mA/cm² to about 600 mA/cm², or from about 1 mA/cm² to about 500 mA/cm², or from about 1 mA/cm² to about 300 mA/cm²;
oxidizing hydroxide ions at the anode to form oxygen gas at a current density of from about 300 mA/cm² to about 3000 mA/cm², or from about 300 mA/cm² to about 2000 mA/cm², or from about 300 mA/cm² to about 1000 mA/cm², or from about 300 mA/cm² to about 500 mA/cm²; and
providing a cathode and a cathode electrolyte in the electrochemical cell; and
forming hydrogen gas at the cathode.

In one aspect, a system to generate hydrogen gas comprises:
an electrochemical cell comprising;
   an anode and an anode electrolyte comprising a metal salt with a metal ion in a lower oxidation state, wherein the anode is configured to:
      oxidize the metal salt with the metal ion in the lower oxidation state to a metal hydroxy salt with the metal ion in a higher oxidation state at a current density of from about 1 mA/cm² to about 1000 mA/cm², or from about 1 mA/cm² to about 600 mA/cm², or from about 1 mA/cm² to about 500 mA/cm², or from about 1 mA/cm² to about 300 mA/cm²; and/or
      oxidize hydroxide ions to oxygen gas at a current density of from about 300 mA/cm² to about 3000 mA/cm², or from about 300 mA/cm² to about 2000 mA/cm², or from about 300 mA/cm² to about 1000 mA/cm², or from about 300 mA/cm² to about 500 mA/cm²; and
   a cathode and a cathode electrolyte comprising water, wherein the cathode is configured to reduce the water to form hydroxide ions and hydrogen gas.

In some examples, the oxidation of the hydroxide ions at the anode to form oxygen gas occurs simultaneously or sequentially, or alone with the oxidation of the metal salt.

In some examples, the cell operates at below about 25% Faradaic efficiency to oxygen during the oxidation of the metal salt and the cell operates at below about 95% Faradaic efficiency to oxygen during the oxidation of the hydroxide ions to form the oxygen gas.

In some examples, the cell operates at low current or high electricity prices or daytime during the oxidation of the metal salt and the cell operates at high current or low electricity prices or nighttime during the oxidation of the hydroxide ions to form the oxygen gas.

In some examples, the anode electrolyte and/or the cathode electrolyte further comprise water.

In some examples, the anode electrolyte and/or the cathode electrolyte further comprise salt water. In some examples, the anode electrolyte and/or the cathode electrolyte further comprise salt water when the anode electrolyte comprise the metal salt. The terms “salt” or “salt water”, as used herein, are used in their conventional senses to refer to a number of different types of salts including, but not limited to, an alkali metal halide such as sodium halide, potassium halide, lithium halide, cesium halide, etc.; an alkali earth metal halide such as calcium halide, strontium halide, magnesium halide, barium halide, etc.; or ammonium halide; or a lanthanide halide. The term “halide,” as used herein, relates to halogens or halide atoms such as fluoride, bromide, chloride, or iodide. In some examples, the salt comprises an alkali metal halide and/or an alkali earth metal halide.

In some examples, the salt may be present in the thermal reactor and may facilitate the evolution of oxygen gas. This salt in the anode electrolyte may get re-circulated with the metal salt solution from the thermal reactor to the anode chamber of the electrochemical cell. Therefore, the salt may be present in both the anode electrolyte as well as in the thermal reactor.

The term “lanthanide halide,” as used herein (e.g., as an example of a “salt”), includes halides of elements from lanthanide series. The element from the lanthanide series can selected from the group consisting of: lanthanum, cerium, praseodymium, neodymium, promethium, samarium, europium, gadolinium, terbium, dysprosium, holmium, erbium, thulium, ytterbium, lutetium, and combinations thereof. Chemically similar elements such as scandium and yttrium, often collectively known as the rare earth elements, are also included in the lanthanide halides used herein. In some examples, the lanthanide halide is a cerium halide e.g., cerium chloride, cerium bromide, or cerium iodide. The lanthanide halide as used herein can be one lanthanide halide or may be a combination of two or more lanthanide halides, where the lanthanide in the one or more lanthanide halides is as noted above. The lanthanide halide can be in anhydrous form or in the form of a hydrate.

The salt concentration in the anode electrolyte and/or the cathode electrolyte and/or the thermal reactor can be from about 1 wt % to about 30 wt %, for example from about 1 wt % to about 20 wt % salt, such as from about 0.1 wt % to about 5 wt %; or between 1 wt % to about 5 wt %, for example from about 2 wt % to about 5 wt %, such as from about 3 wt % to about 5 wt %, for example from about 5 wt % to about 10 wt %, such as from about 5 wt % to about 8 wt %, for example from about 2 wt % to about 6 wt %, such as from about 1 wt % to about 3 wt %.

In some examples, the anode electrolyte comprising the metal salt further comprises salt (for example only, sodium chloride, or potassium chloride, or lithium chloride, or calcium chloride, or sodium bromide, or potassium bromide, or lithium bromide, or calcium bromide or lanthanide halide or respective iodide salts) and includes from about 1 wt % to about 30 wt % salt, for example from 1 wt % to about 25 wt % salt, such as from about 1 wt % to about 2( )wt % salt, for example from 1 wt % to about 10 wt % salt, such as from about 1 wt % to about 5 wt % salt, for example from 5 wt % to about 30 wt % salt, such as from about 5 wt % to about 20 wt % salt, for example from 5 wt % to about 10 wt % salt, such as from about 8 wt % to about 30 wt % salt, for example from about 8 wt % to about 25 wt % salt, such as from about 8 wt % to about 20 wt % salt, for example from about 8 wt % to about 15 wt % salt, such as from about 10 wt % to about 30 wt % salt, for example from about 10 wt % to about 25 wt % salt, such as from about 10 wt % to about 20 wt % salt, for example from about 10 wt % to about 15 wt % salt, such as from about 15 wt % to about 30 wt % salt, for example from about 15 wt % to about 25 wt % salt, such as from about 15 wt % to about 20 wt % salt, for example from about 20 wt % to about 30 wt % salt, such as from about 20 wt % to about 25 wt % salt. The salt in water would constitute saltwater as described herein.

In some examples, the water in the anode electrolyte and/or the cathode electrolyte can be between about 10 wt % to about 80 wt %, for example from about 20 wt % to about 80 wt %, such as from about 40 wt % to about 80 wt %, for example from 40 wt % to about 70 wt %, such as from about 40 wt % to about 60 wt %, for example from 40 wt iii to about 50 wt %, such as from about 50 wt % to about 80 wt %, for example from 50 wt % to about 70 wt %, such as from about 50 wt % to about 60 wt?, for example from 60 wt % to about 80 wt %, such as from about 60 wt % to about 70 wt %, for example from 70 wt % to about 80 wt %, such as from about 60 wt % to about 85 wt %, for example from 60 wt % to about 75 wt %, such as from about 60 wt % to about 65 wt %, for example from 70 wt % to about 75 wt %, such as from about 75 wt.% to about 80 wt % of the electrolyte depending on the amount of the metal salt and optionally the salt.

In some examples, the anode electrolyte and/or the cathode electrolyte further comprises an alkali metal hydroxide or an alkali earth metal hydroxide. Examples of the alkali metal and the alkali earth metal have been provided herein. In some examples, the anode electrolyte comprises potassium hydroxide or sodium hydroxide. In some examples, the anode electrolyte comprises the alkali metal hydroxide, e.g., KOH or NaOH or an alkali earth metal hydroxide, e.g., Ca(OH)₂ or Mg(OH)₂ in an amount of between 1 M to about 6 M, or between 1 M to about 5 M, or between 1 M to about 4 M, or between 1 M to about 3 M, or between 1 M to about 2 M, or between 2 M to about 7 M, or between 3 M to about 6 M, or between 4 M to about 6 M.

The “metal ion” or “metal” or “metal ion of the metal salt” or “metal ion of the metal hydroxy salt” as used herein, includes any metal ion capable of being converted from a lower oxidation state to a higher oxidation state. Examples of the metal ion in the corresponding metal salt or the metal hydroxy salt include, but are not limited to: manganese, iron, chromium, selenium, copper, tin, silver, cobalt, uranium, lead, mercury, vanadium, bismuth, titanium, ruthenium, osmium, europium, zinc, cadmium, gold, nickel, palladium, platinum, rhodium, iridium, technetium, rhenium, molybdenum, tungsten, niobium, tantalum, zirconium, hafnium, and combination thereof. In some examples, the metal ion in the corresponding metal salt or the metal hydroxy salt can include, but is not limited to: iron, copper, tin, chromium, manganese, selenium, tantalum, or combination thereof. In some examples, the metal ion in the corresponding metal salt or the metal hydroxy salt is copper. In some examples, the metal ion in the corresponding metal salt or the metal hydroxy salt is tin. In some examples, the metal ion in the corresponding metal salt or the metal hydroxy salt is iron. In some examples, the metal ion in the corresponding metal salt or the metal hydroxy salt is chromium. In some examples, the metal ion in the corresponding metal salt or the metal hydroxy salt is manganese. In some examples, the metal ion in the corresponding metal salt or the metal hydroxy salt is selenium. In some examples, the metal ion in the corresponding metal salt or the metal hydroxy salt is tantalum. in some examples, the metal ion in the corresponding metal salt or the metal hydroxy salt is platinum.

The term “oxidation state” as used herein when referring to the metal ion of the metal salt or the metal hydroxy salt, includes the degree of oxidation the metal ion in the metal salt or the metal hydroxy salt. In some examples, the oxidation state is the net charge on the metal ion, As used herein, the term “lower oxidation state” refers to the relative oxidation state when compared to the “higher oxidation state,” i.e., with a lower oxidation number when compared to that of the same metal ion when in the higher oxidation state. The “lower oxidation state” may be represented as n+ in Mⁿ⁺ illustrating the lower oxidation state of the metal ion, For example, the lower oxidation state of the metal ion may be 1+, 2+, 3+, 4+, 5+, or 6+. Similarly, as used herein, the term “higher oxidation state” refers to the relative oxidation state when compared to the “lower oxidation state,” i.e., with a higher oxidation number when compared to that of the same metal ion when in the lower oxidation state. The “higher oxidation state” may be represented as m+ in M^{m+} illustrating the higher oxidation state of the metal ion. For example, the higher oxidation state of the metal ion may be 2+, 3+, 4+, 5+, 6+, 7+.

In some examples, the metal salt with the metal ion in the lower oxidation state is selected from the group consisting of: CuCl, CuBr, CuI, FeCl₂, FeBr₂, FeI₂, SnCl₂, SnBr₂, SnI₂, Cu₂SO₄, FeSO₄, SnSO₄, Cu₃PO₄, Fe₃(PO₄)₂, and Sn₃(PO₄)₂.

In some examples, the metal hydroxy salt with the metal ion in the higher oxidation state is selected from the group consisting of: Cu(OH)ₓCl_{y}, Cu(OH)ₓBr_{y}, Cu(OH)ₓI_{y}, Fe(OH)ₓCl_{y}, Fe(OH)ₓBr_{y}, Fe(OH)ₓI_{y}, Sn(OH)ₓCl_{y}, Sn(OH)ₓBr_{y}, Sn(OH)ₓI_{y}, Cu₂(OH)ₓ(SO₄)_{y}, Fe(OH)ₓ(SO₄)_{y}, Sn(OH)ₓ(SO₄)_{y}, Cu₃(OH)ₓ(PO₄)_{y}, Fe₃(OH)ₓ(PO₄)_{y}, and Sn₃(OH)ₓ(PO₄)_{y}, wherein x and y are integers and add to balance the charge on the metal.

In some examples,
the metal salt with the metal ion in the lower oxidation state is CuCl and the metal hydroxy salt with the metal ion in the higher oxidation state is Cu(OH)ₓCl_{y};
the metal salt with the metal ion in the lower oxidation state is CuBr and the metal hydroxy salt with the metal ion in the higher oxidation state is Cu(OH)ₓBr_{y};
the metal salt with the metal ion in the lower oxidation state is CuI and the metal hydroxy salt with the metal ion in the higher oxidation state is Cu(OH)ₓI_{y};
the metal salt with the metal ion in the lower oxidation state is FeCl₂ and the metal hydroxy salt with the metal ion in the higher oxidation state is Fe(OH)ₓCl_{y};
the metal salt with the metal ion in the lower oxidation state is FeBr₂ and the metal hydroxy salt with the metal ion in the higher oxidation state is Fe(OH)ₓBr_{y}; or
the metal salt with the metal ion in the lower oxidation state is FeI₂ and the metal hydroxy salt with the metal ion in the higher oxidation state is Fe(OH)ₓI_{y},
wherein x, and y are integers.

In some examples, the metal hydroxy salt with the metal ion in the higher oxidation state is Mₓ^{m+}X_{y}(OH)_{(mx-y)}, MₓX_{y}(OH)_{(2x-y)}, MₓX_{y}(OH)_{(3x-y)}, MₓX_{y}(OH)_{(4x-y)}, or combinations thereof, wherein M is the metal ion, X is a counter anion, and m, x, and y are integers (depending on the valences of M and X). In some examples, the x and y are integers independently from 1 to 10, for example from 1 to 8, such as from 1 to 5.

Some examples of the reaction of the metal ions at the anode are as shown in Table I below (SHE is standard hydrogen electrode). The theoretical values of the anode potential are also shown. It is to be understood that some variation from these voltages may occur depending on conditions, pH, concentrations of the electrolytes, etc., and such variations are well within the scope of the systems and methods of the present disclosure.

TABLE I

| | Anode |
|---|---|
| | Potential |
| Anode Reaction | (V vs. SHE) |
| Ag⁺ → Ag²⁺ + e⁻ | −1.98 |
| Co²⁺ → Co³⁺ + e⁻ | −1.82 |
| Pb²⁺ → Pb⁴⁺ + 2e⁻ | −1.69 |
| Ce³⁺ → Ce⁴⁺ + e⁻ | −1.44 |
| 2Cr³⁺ + 7H₂O → Cr₂O₇²⁻ + 14H⁺ + 6e⁻ | −1.33 |
| TI⁺ → TI³⁺ + 2e⁻ | −1.25 |
| Hg₂²⁺ → 2Hg²⁺ + 2e⁻ | −0.91 |
| Fe²⁺ → Fe³⁺ + e⁻ | −0.77 |
| V³⁺ + H₂O → VO²⁺ + 2H⁺ + e⁻ | −0.34 |
| U⁴⁺ + 2H₂O→ UO²⁺ + 4H⁺ + e⁻ | −0.27 |
| Bi⁺ → Bi³⁺ + 2e⁻ | −0.20 |
| TI³⁺ + H₂O → TIO²⁺ + 2H⁺ + e⁻ | −0.19 |
| Cu⁺ → Cu²⁺ + e⁻ | −0.16 |
| UO₂⁺ → UO₂²⁺ + e⁻ | −0.16 |
| Sn²⁺ → Sn⁴⁺ + 2e⁻ | −0.15 |
| Ru(NH₃)₆²⁺ → Ru(NH₃)₆³⁺ + e⁻ | −0.10 |
| V²⁺ → V³⁺ + e⁻ | +0.26 |
| Eu²⁺ → Eu³⁺ + e⁻ | +0.35 |
| Cr²⁺ → Cr³⁺ + e⁻ | +0.42 |
| U³⁺ → U⁴⁺ + e⁻ | +0.52 |

In some examples, the metal ion of the metal salt described herein may be chosen based on the solubility of the metal salt in the anode electrolyte and/or the cell voltage desired for the metal oxidation from the lower oxidation state to the higher oxidation state.

It is to be understood that the metal salt with the metal ion in the lower oxidation state and the metal salt with the metal ion in the higher oxidation state (i.e., the metal hydroxy salt) may be both present in the anode electrolyte exiting the anode chamber depending on the oxidation.

Owing to the oxidation of the metal salt from the lower oxidation state to the higher oxidation state at the anode, the amount of the metal salt in the lower oxidation state is different in the anode electrolyte entering the anode chamber and exiting the anode chamber.

In some examples, the metal ion in the anode electrolyte is a mixed metal ion. For example, if the anode electrolyte includes a metal salt with a copper ion in the lower oxidation state and a copper ion in the higher oxidation state, the anode electrolyte may also contain another metal ion such as, but not limited to, iron. In some examples, the presence of a second metal ion in the anode electrolyte may be beneficial in lowering the total energy of the electrochemical reaction.

Some examples of the metal salt with the metal ion in the lower oxidation state that may be used in the systems and methods provided herein include, but not limited to, copper (I) salt, iron (II) salt, tin (II) salt, chromium (II) salt, zinc (II) salt, etc.

In some examples, the concentration of the metal salt with the metal ion in the lower oxidation state entering the anode chamber is more than about 0.01 M, such as more than about 0.05 M, for example from about 0.01 M to about 2 M, such as from about 0.01 M to about 1.8 M, for example from about 0.01 M to about 1.5 M, such as from about 0.01 M to about 1.2 M, for example from about 0.01 M to about 1 M, such as from about 0.01 M to about 0.8 M, for example from about 0.01 M to about 0.6 M, such as from about 0.01 M to about 0.5 M, for example from about 0.01 M to about 0.4 M, such as from about 0.01 M to about 0.1 M, for example from about 0.01 M to about 0.05 M, such as from about 0.05 M to about 2 M, for example from about 0.05 M to about 1.8 M, such as from about 0.05 M to about 1.5 M, for example from about 0.05 M to about 1.2 M, such as from about 0.05 M to about 1 M, for example from about 0.05 M to about 0.8 M, such as from about 0.05 M to about 0.6 M, for example from about 0.05 M to about 0.5 M, such as from about 0.05 M to about 0.4 M, for example from about 0.05 M to about 0.1 M, such as from about 0.1 M to about 2 M, for example from about 0.1 M to about 1.8 M, such as from about 0.1 M to about 1.5 M, for example from about 0.1 M to about 1.2 M, such as from about 0.1 M to about 1 M, for example from about 0.1 M to about 0.8 M, such as from about 0.1 M to about 0.6 M, for example from about 0.1 M to about 0.5 M, such as from about 0.1 M to about 0.4 M, for example from about 0.5 M to about 2 M, such as from about 0.5 M to about 1.8 M, for example from about 0.5 M to about 1.5 M, such as from about 0.5 M to about 1.2 M, for example from about 0.5 M to about 1 M, such as from about 0.5 M to about 0.8 M, for example from about 0.5 M to about 0.6 M, such as from about 1 M to about 2 M, for example from about 1 M to about 1.8 M, such as from about 1 M to about 1.5 M, for example from about 1 M to about 1.2 M, such as from about 1.5 M to about 2 M.

In some examples, the concentration of the metal hydroxy salt (with the metal ion in the higher oxidation state) exiting the anode chamber is from about 0.1 M to about 2 M, for example from about 0.1 M to about 1.8 M, such as from about 0.1 M to about 1.5 M, for example from about 0.1 M to about 1.2 M, such as from about 0.1 M to about 1 M, for example from about 0.1 M to about 0.8 M, such as from about 0.1 M to about 0.6 M, for example from about 0.1 M to about 0.5 M such as from about 0.1 M to about 0.4 M, for example from about 0.5 M to about 2 M, such as from about 0.5 M to about 1.8 M, for example from about 0.5 M to about 1.5 M, such as from about 0.5 M to about 1.2 M, for example from about 0.5 M to about 1 M., such as from about 0.5 M to about 0.8 M, for example from about 0.5 M to about 0.6 M, such as from about 1 M to about 2 M, for example from about 1 M to about 1.8 M, such as from about 1 M to about 1.5 M, for example from about 1 M to about 1.2 M such as from about 1.5 M to about 2 M.

It is to be understood that any combination of the aforementioned concentrations for the metal salt with the metal ions in the lower oxidation state and the metal hydroxy salt with the metal ions in the higher oxidation state can be combined to achieve high efficiency.

In some examples, in the anode electrolyte, the concentration of the metal salt with the metal ion in the lower oxidation state is from about 0.01 M to about 2 M, for example from about 0.01 M to about 1.5 M, such as from about 0.01 M to about 1 M, for example from about 0.1 M to about 1 M, and the concentration of the metal hydroxy salt is from about 0.2 M to about 2 M, for example from about 0.3 M to about 2 M, such as from about 0.5 M to about 1M, for example from about 0.3 M to about 1 M.

In some examples, the concentration of the metal salt with the metal ion in the lower oxidation state, and the concentration of the metal hydroxy salt with the metal ion in the higher oxidation state, each individually or collectively, may affect the performance of each of the electrochemical cell/reaction, and the thermal reactor/reaction.

In some examples, concentration of the metal salt with the metal ion in the lower oxidation state entering the electrochemical reaction is from about 0.1 M to about 1 M, and the concentration of the metal salt with the metal ion in the lower oxidation state entering the thermal reaction (exiting the electrochemical reaction) is from about 0.01 M to about 0.9 M.

In some examples, the temperature of the anode electrolyte in the electrochemical cell/reaction is from about 50° C. to about 100° C., for example from about 60° C. to about 100° C., such as from about 70° C. to about 100° C.

The electrochemical cells in the methods and systems described herein may be membrane electrolyzers. Each electrochemical cell may be a single cell or may be a stack of cells connected in series or in parallel. The electrochemical cell may be a stack of 5 or 6 or 50 or 100 or more electrolyzers connected in series or in parallel. Each cell comprises an anode, a cathode, and an ion exchange membrane.

In some examples, the electrolyzers provided herein are monopolar electrolyzers. In the monopolar electrolyzers, the electrodes may be connected in parallel where all anodes and all cathodes are connected in parallel. In such monopolar electrolyzers, the operation takes place at high amperage and low voltage. In sonic examples, the electrolyzers provided herein are bipolar electrolyzers. In the bipolar electrolyzers, the electrodes may be connected in series where all anodes and all cathodes are connected in series. In such bipolar electrolyzers, the operation takes place at low amperage and high voltage. In some examples, the electrolyzers are a combination of monopolar and bipolar electrolyzers and may be called hybrid electrolyzers.

In some examples of the bipolar electrolyzers as described above, the cells are stacked serially constituting the overall electrolyzer and are electrically connected in two ways. In bipolar electrolyzers, a single plate, called a bipolar plate, may serve as a base plate for both the cathode and anode. The electrolyte solution may be hydraulically connected through common manifolds and collectors internal to the cell stack. The stack may be compressed externally to seal all frames and plates against each other, which is typically referred to as a filter press design. In some examples, the bipolar electrolyzer may also be designed as a series of cells, individually sealed, and electrically connected through back-to-back contact, typically known as a single element design. The single element design may also be connected in parallel, in which case it would be a monopolar electrolyzer.

In some examples, the cell size may be denoted by the active area dimensions. In some examples, the active area of the electrolyzers used herein may range from about 0.5 meters to about 1.5 meters tall and from about 0.4 meters to about 3 meters wide. In some examples, the individual chamber thicknesses range from about 0.5 mm to about 50 mm.

The electrochemical cells used in the methods and systems provided herein can be made from corrosion resistant materials. Corrosion resistant materials include, but are not limited to, polyvinylidene fluoride, viton, polyether ether ketone, fluorinated ethylene propylene, fiber-reinforced plastic, halar, ultem (PEI), perfluoroalkoxy, tefzel, tyvar, fibre-reinforced plastic-coated with derakane 441-400 resin, graphite, akot, tantalum, hastelloy C2000, titanium Gr.7, titanium Gr.2, or combinations thereof. In some examples, these materials can be used for making the electrochemical cells and/or its components including, but not limited to, tank materials, piping, heat exchangers, pumps, reactors, cell housings, cell frames, electrodes, instrumentation, valves, and all other balance of plant materials. In some examples, the material used for making the electrochemical cell and its components include, but not limited to, titanium Gr.2.

In some examples, the anode may contain a corrosion stable, electrically conductive base support. Such as, but not limited to, amorphous carbon, such as carbon black, fluorinated carbons available under the trademark SFC™ carbons, Other examples of electrically conductive base materials include, but are not limited to, sub-stoichiometric titanium oxides, such as, Magneli phase sub-stoichiometric titanium oxides having the formula TiOₓ wherein x ranges from about 1.67 to about 1.9. Some examples of titanium sub-oxides include, without limitation, titanium oxide Ti₄O₇. Electrically conductive base materials can also include, without limitation, metal titanates such as MₓTi_{y}O_{z} such as MₓTi₄O₇, etc. Some other examples include, without limitation, iron (in form of an alloy e.g., steel), titanium, nickel, and their alloys. In some examples, carbon based materials provide a mechanical support or as blending materials to enhance electrical conductivity but may not be used as catalyst support to prevent corrosion.

In some examples, the anode is not coated with an electrocatalyst. In some examples, the anode is made of an electro conductive base metal such as titanium coated with or without electrocatatysts. Some examples of electrically conductive base materials include, but are not limited to, sub-stoichiometric titanium oxides, such as, Magneli phase sub-stoichiometric titanium oxides having the formula TiOₓ wherein x ranges from about 1.67 to about 1.9. Some examples of titanium sub-oxides include, without limitation, titanium oxide Ti₄O₇. The electrically conductive base materials can also include, without limitation, metal titanates such as MₓTi_{y}O_{z}, such as MₓTi₄O₇, etc. Some other examples include, without limitation, iron (in form of alloy e.g., steel), titanium, nickel and their alloys.

Examples of electrocatalysts have been described herein and include, but are not limited to, highly dispersed metals or alloys of the platinum group metals, such as platinum, palladium, ruthenium, rhodium, iridium, or their combinations such as platinum-rhodium, platinum-ruthenium, titanium mesh coated with PtIr mixed metal oxide or titanium coated with galvanized platinum; electrocatalytic metal oxides, such as, but not limited to, IrO₂; gold, tantalum, carbon, graphite, organometallic macrocyclic compounds, and other electrocatalysts well known in the art. The electrodes may be coated with electrocatalysts using processes well known in the art.

In some examples, the electrodes described herein (e.g., the anode and the cathode) comprise a porous homogeneous composite structure or a heterogeneous, layered type composite structure wherein each layer can have a distinct physical and compositional make-up, e.g., porosity and electroconductive base, to prevent flooding, and loss of the three phase interface, and resulting electrode performance.

In some examples, the electrodes described herein may include anodes and cathodes having porous polymeric layers on or adjacent to the anode electrolyte or the cathode electrolyte solution side of the electrode, which may assist in decreasing penetration and electrode fouling. Stable polymeric resins or films may be included in a composite electrode layer adjacent to the anode electrolyte or the cathode electrolyte comprising resins formed from non-ionic polymers, such as polystyrene, polyvinyl chloride, polysulfone, etc., or ionic-type charged polymers like those formed from polystyrenesulfonic acid, sulfonated copolymers of styrene and vinylbenzene, carboxylated polymer derivatives, sulfonated or carboxylated polymers having partially or totally fluorinated hydrocarbon chains and aminated polymers like polyvinylpyridine. Stable microporous polymer films may also be included on the dry side to inhibit electrolyte penetration. In some examples, the gas-diffusion cathodes include such cathodes known in the art that are coated with high surface area coatings of precious metals such as gold and/or silver, precious metal alloys, nickel, and the like.

In some examples, the ion exchange membrane is an anion exchange membrane (for alkaline conditions) or a cation exchange membrane (for acidic conditions). In some examples, the cation exchange membranes in the electrochemical cell, as disclosed herein, are conventional and are available from, for example, Asahi Kasei of Tokyo, Japan; or from Membrane International of Glen Rock, N.J., or DuPont, in the USA, Examples of CEMs include, but are not limited to, N2030WX (Dupont), F8020/F8080 (Flemion), and F6801 (Aciplex). CEMs that are desirable in the methods and systems herein may have minimal resistance loss, greater than 90% selectivity, and high stability. AEMs, in the methods and systems described herein are exposed to concentrated metal salt containing anode electrolytes. For example, a fully quarternized amine containing polymer may be used as an AEM.

Examples of cationic exchange membranes include, but are not limited to, cationic membrane comprising a perfluorinated polymer containing anionic groups, for example sulphonic and/or carboxylic groups. However, it may be appreciated that in some examples, depending on the need to restrict or allow migration of a specific cation or an anion species between the electrolytes, a cation exchange membrane that is more restrictive and thus allows migration of one species of cation while restricting the migration of another species of cation may be used. Similarly, in some examples, depending on the need to restrict or allow migration of a specific anion species between the electrolytes, an anion exchange membrane that is more restrictive and thus allows migration of one species of anion while restricting the migration of another species of anion may be used. Such restrictive cation exchange membranes and anion exchange membranes are commercially available and can be selected by one ordinarily skilled in the art.

In some examples, the membrane may be selected such that it can function in an acidic and/or alkaline electrolytic solution as appropriate. Other desirable characteristics of the membrane include high ion selectivity, low ionic resistance, high burst strength, and high stability in electrolytic solution in a temperature range of room temperature to 150° C. or higher. In some examples, it is desirable that the ion exchange membrane reduce, minimize, or even prevent the transport of the metal ions from the anode electrolyte to the cathode electrolyte.

In some examples, the membrane is stable in the range of from about 0° C. to about 150° C., for example from about 0° C. to about 100° C., such as from about 0° C. to about 90° C., for example from about 0° C. to about 80 ⁰C, such as from about 0° C. to about 70° C. for example from about 0° C. to about 60° C., such as from about 0° C. to about 50° C., for example from about 0° C. to about 40° C., such as from about 0° C. to about 30° C., or higher. For other examples, it may be useful to utilize an ion-specific ion exchange membrane that allows migration of one type of cation but not another, or migration of one type of anion and not another, to achieve a desired product or products in an electrolyte.

The ohmic resistance of the membrane may affect the voltage drop across the anode and cathode, e.g., as the ohmic resistance of the membrane increase, the voltage across the anode and cathode may increase, and vice versa. Membranes that can be used include, but are not limited to, a membrane with relatively low ohmic resistance and relatively high ionic mobility, or a membrane with relatively high hydration characteristics that increase with temperatures, and thus decreasing the ohmic resistance. By selecting a membrane with lower ohmic resistance known in the art, the voltage drop across the anode and the cathode at a specified temperature can be lowered.

In some examples, the anode electrolyte comprises from about 0.3 M to about 5 M, for example from about 0.3 M to about 4.5 M, such as from about 0.3 M to about 4 M, for example from about 0.3 M to about 3.5 M, such as from about 0.3 M to about 3 M, for example from about 0.3 M to about 2.5 M, such as from about 0.3 M to about 2 M, for example from about 0.3 M to about 1.5 M, such as from about 0.3 M to about 1 M, for example from about 0.3 M to about 0.5 M, such as from about 0.5 M to about 5 M, for example from about 0.5 M to about 4.5 M, such as from about 0.5 M to about 4 M, for example from about 0.5 M to about 3.5 M, such as from about 0.5 M to about 3 M, for example from about 0.5 M to about 2.5 M, such as from about 0.5 M to about 2 M, for example from about 0.5 M to about 1.5 NI, such as from about 0.5 M to about 1 M, for example from about 1 M to about 5 M, such as from about 1 M to about 4.5 M, for example from about 1 M to about 4 M, such as from about 1 M to about 3.5 M, for example from about 1 M to about 3 M, such as from about 1 M to about 2.5 M, for example from about 1 M to about 2 M, such as from about 1 M to about 1.5 M, for example from about 2 M to about 5 M, such as from about 2 M to about 4.5 M, such as from about 2 M to about 4 M, for example from about 2 M to about 3.5 M, such as from about 2 M to about 3 M, for example from about 2 M to about 2.5 M, such as from about 3 M to about 5 M, for example from about 3 M to about 4.5 M, such as from about 3 M to about 4 M, for example from about 3 M to about 3.5 M, such as from about 4 M to about 5 M of the total metal salt solution (comprising both the metal salt with the metal ion in the lower oxidation state and the metal hydroxy salt with the metal ion in the higher oxidation state).

Depending on the degree of alkalinity desired in the cathode electrolyte, the pH of the cathode electrolyte may be adjusted and in some examples is maintained from about 7 to about 15, for example from about 7 to about 14 or greater, such as from about 7 to about 13, for example from about 7 to about 12, such as from about 7 to about 11, for example from about 10 to about 14 or greater, such as from about 10 to about 13, for example from about 10 to about 12, such as from about 10 to about 11. In some examples, the pH of the cathode electrolyte may be adjusted to any value from about 7 to about 14 or greater, for example a pH less than about 12, such as a pH of 7.0, 7.5, 8.0, 8.5, 9.0, 9.5, 10.0, 10.5, 11.0, 11.5, 12.0, 12.5, 13.0, 13.5, 14.0, and/or greater.

The voltage across the anode and cathode may be dependent on several factors including he difference in pH between the anode electrolyte and the cathode electrolyte (as can be determined by the Nernst equation). In some examples, the pH of the anode electrolyte may be adjusted to a value of from about 9 to about 15 depending on the desired operating voltage across the anode and cathode.

As used herein, the term “voltage” includes a voltage or a bias applied to or drawn from an electrochemical cell that drives a desired reaction between the anode and the cathode in the electrochemical cell. in some examples, the desired reaction may be the electron transfer between the anode and the cathode such that hydrogen gas is formed at the cathode and the metal salt is oxidized at the anode. The voltage may be applied to the electrochemical cell by any means for applying current across the anode and the cathode of the electrochemical cell. Such means are well known in the art and include, without limitation, devices, such as, an electrical power source, a fuel cell, a device powered by sunlight, a device powered by wind, and combinations thereof. The type of electrical power source to provide the current can be any power source known to one skilled in the art. In some examples, the voltage may be applied by connecting the anode and the cathode of the cell to an external direct current (DC) power source. The power source can be an alternating current (AC) rectified into The DC power source may have an adjustable voltage and current to apply a requisite amount of the voltage to the electrochemical cell.

In some examples, the current applied to the electrochemical cell is at least about 50 mA/cm²; or at least 100 mA/cm²; or at least 150 mA/cm²; or at least 200 mA/cm²; or at least 500 mA/cm²; or at least 1000 mA/cm²; or at least 1500 mA/cm²; or at least 2000 mA/cm²; or at least 2500 mA/cm², for example from 1100-2500 mA/cm², such as from about 100-2000 mA/cm², for example from 100-1500mA/cm², such as from about 100-1000 mA/cm², for example from 100-500 mA/cm², such as from about 200-2500 mA/cm², for example from 200-2000 mA/cm², such as from about 200-1500 mA/cm², for example from 200-1000 mA/cm², such as from about 200-500 mA/cm², for example from 500-2500 mA/cm², such as from about 500-2000 mA/cm², for example from 500-1500 mA/cm², such as from about 500-1000 mA/cm², for example from 1000-2500 mA/cm², such as from about 1000-2000 mA/cm², for example from 1000-1500 mA/cm², such as from about 1500-2500 mA/cm², for example from 1500-2000 mA/cm², such as from about 2000-2500 mA/cm².

In some examples, at least a portion of the anode electrolyte is transferred outside the electrochemical cell to a thermal reactor or to a second electrochemical cell using any means for transferring the solution. The examples include, without limitation, conduits, pipes, tubes, and other means for transferring the liquid solutions. In some examples, the conduits attached to the systems also include means for transferring gases such as, but not limited to, pipes, tubes, tanks, and the like.

In all the systems provided herein, the use of electrochemical and/or thermal reaction may be varied with time throughout the day. For example, the thermal reactor/reaction may be run during peak power price times as compared to electrochemical cell/reaction thereby reducing the energy use. For example, the thermal reactor/reaction may be run in the daytime while the electrochemical cell/reaction may be run in the nighttime in order to save the cost of energy or vice versa.

The systems provided herein include a thermal reactor that carries out the thermal reaction of the anode electrolyte comprising metal hydroxy salt to form the oxygen gas. The “reactor” or the “unit” as used herein is any vessel or unit in which the reaction provided herein, is carried out. The thermal reactor is configured to heat the anode electrolyte comprising the metal hydroxy salt to form the oxygen gas and the metal salt (with the metal ions in the lower oxidation state). The reactor may be any means for contacting the contents as mentioned above. Such means or such reactor are well known in the art and include, but not limited to, pipe, column, duct, tank, series of tanks, container, tower, conduit, and the like. The reactor may be equipped with one or more of controllers to control temperature sensor, pressure sensor, control mechanisms, inert gas injector, etc. to monitor, control, and/or facilitate the reaction. In some examples, the reactor is made from corrosion resistant materials.

In some examples, the thermal reactor system may be one reactor or is a series of reactors connected to each other. The thermal reactor may he a stirred tank. The stirring may facilitate distribution of the heat into the metal hydroxy salt thereby accelerating the thermal reaction to form the oxygen gas. The thermal reactor may be made of material that is compatible with the aqueous or the saltwater streams containing metal salt flowing between the systems. In some examples, the thermal reactor is made of corrosion resistant materials that are compatible with metal salt containing water, such materials include, titanium, steel etc.

The reactor effluent gases may be collected and optionally compressed. The liquid leaving the tower maybe cooled and recycled back to the tower or may be split part being recycled to the tower and the remainder may be recycled to the anode chamber of the electrochemical cell. The construction material of the plant or the systems may include prestressed brick linings, Hastealloys B and C, inconel, dopant grade titanium (e.g., AKOT, Grade II), tantalum, Kynar, Teflon, PEEK, glass, or other polymers or plastics. The reactor may also be designed to continuously flow the anode electrolyte in and out of the reactor.

In some examples, the thermal reaction of the metal hydroxy salt to form the oxygen gas is carried out in the reactor under one or more reaction conditions including, but not limited to, the temperature of between 50-500° C. or between 50-400° C. or between 50-300° C. or between 50-200° C. or between 50-100° C.; pressure of between 10-500 psig or between 10-400 psig or between 10-300 psig or between 10-200 psig or between 10-100 psig, or between 50-350 psig or between 200-300 psig; presence of hydroxide ions; presence of catalyst; pH of more than 10; or combinations thereof.

In some examples, the thermal reaction of the metal hydroxy salt to form the oxygen gas can be facilitated by the presence of a catalyst. Examples of catalysts include, but not limited to, metal oxide, such as, e.g., manganese oxide, ruthenium oxide, silicon oxide, iron oxide, or aluminum oxide, the like; and/or a nonmetal salt (or salt), such as e.g., alkali metal halide or alkali earth metal halide or lanthanide halide. In some examples, ions, such as, e.g., CO²⁺, Ni²⁺, Fe²⁺, Ag⁺, Cu²⁺, Mn²⁺, Sn⁴⁺, Pb²⁺, Ca²⁺, Cl⁻, CO₃²⁻, MoO₄²⁻, MoO₄²⁻, SiO₄⁴⁻, may act as a catalyst for the evolution of the oxygen gas in the thermal reactor. In some examples, the concentration of these ions may be between 10⁻¹⁰ to 10⁻¹ M, or between 10⁻⁹ to 10⁻⁴ M.

In some examples, the thermal reaction of the metal hydroxy salt to form the oxygen gas is facilitated by the presence of hydroxide ions or a pH of more than 10 or between 10-12 or between 10-14.

Reaction heat may be removed by vaporizing water or by using heat exchange units (described further herein). In some examples, a cooling surface may not be required in the reactor and thus no temperature gradients or close temperature control may be needed.

In some examples, the system is heat integrated to minimize operating costs. Various heat integration approaches can be used in the methods and systems provided herein. In some examples, the system further comprises a feed/effluent heat exchanger between the electrolysis cell and the thermal reactor that serves to recover heat from the solution leaving the thermal reactor/reaction into the stream entering the thermal reactor/reaction. In some examples, a portion of the heat used in the thermal reactor/reaction is provided by heat from another process. This heat from another process may be waste heat that is not economically recoverable under normal conditions or is on-purpose heat from a clean source of heat such as a solar thermal system, a geothermal system, or a nuclear process. In some examples, the heat from another process may be that generated by the compression of hydrogen up to delivery pressure or some other fluid pressurization work.

In some examples, at least one of the electrolysis cell/reaction or the thermal reactor/reaction is operated at elevated pressure. Because of the requirements for hydrogen delivery pressure, in some examples, it may be advantageous to operate the electrolyzer at pressures above atmospheric. One concern with high pressure operation of a water-splitting electrolyzer generating hydrogen at the cathode and oxygen at the anode may be the risk of internal component failure leading to an explosive mixture. In some examples, oxygen is not generated or is generated in very small amounts within the electrolyzer, thereby lowering this risk. In some examples, the minimal amount of the oxygen gas formed at the anode may contaminate the hydrogen gas formed at the cathode. In such examples, a hydrogen oxygen separator may be operably connected to the electrochemical system method herein to separate the hydrogen gas from the oxygen gas. Examples of such separators include, without limitation, a membrane or other porous separator. Such separators are commercially available.

In some examples, operating the thermal reactor/reaction at lower pressure may facilitate release of oxygen. Thus, operating the thermal reactor/reaction at lower pressure may be done to reduce the overall cost of production, for reasons of process safety or for other reasons. For example, the electrolysis cell may be operated at higher pressure to reduce the cost of compression of the hydrogen while the thermal reactor/reaction is operated at lower pressure to facilitate oxygen evolution. In some examples, the thermal reactor/reaction may occur under vacuum and then be compressed to atmospheric pressure. The economics of the reaction may depend on the relative sources of heat and costs of compression.

In some examples, the electrochemical cell is operated at pressure between about 40-500 psi; or 40-400 psi; or 40-300 psi; or 40-200 psi; or 40-100 psi; or 100-200 psi; or 200-300 psi; or 300-400 psi; or 400-500 psi; or 500-3000 psi. In some examples, the thermal reaction is operated at pressure between about 14-300 psi; or 14-200 psi; or 14-100 psi; or 14-50 psi.

In some examples, the systems may include one reactor or a series of multiple reactors connected to each other or operating separately. The reactor may be a packed bed such as, but not limited to, a hollow tube, pipe, column or other vessel filled with packing material. The reactor may be a trickle-bed reactor. In some examples, the reactor may be a tray column or a spray tower. Any of the configurations of the reactor described herein may be used to carry out the methods/systems provided herein.

The metal hydroxy salt solution may be agitated by stirring or shaking or any desired technique, e.g., the reaction may be carried out in a column, such as a packed column, or a trickle-bed reactor or reactors described herein. For example, when the oxygen gas is formed, a counter-current technique may be employed wherein the oxygen gas passes upwardly through a column or reactor and the metal hydroxy salt solution is passed downwardly through the column or reactor.

A variety of packing material of various shapes, sizes, structure, wetting characteristics, form, and the like may be used in the packed bed or trickle bed reactor, described herein. The packing material includes, but not limited to, polymer (e.g., only Teflon PTFE), ceramic, glass, metal, natural (wood or bark), or combinations thereof. In some examples, the packing can be structured packing or loose or unstructured or random packing or combination thereof. The structured packing includes unflowable corrugated metal plates or gauzes. In some examples, the structured packing material individually or in stacks fits fully in the diameter of the reactor. The unstructured packing or loose packing or random packing includes flow able void filling packing material.

Examples of loose or unstructured or random packing material include, but not limited to, Raschig rings (such as in ceramic material), pall rings (e.g., in metal and plastic), lessing rings, Michael Bialecki rings (e.g., in metal), bed saddles, intalox saddles (e.g., in ceramic), super intalox saddles, tellerette® ring (e.g., spiral shape in polymeric material), etc.

Examples of structured packing material include, but not limited to, thin corrugated metal plates or gauzes (honeycomb structures) in different shapes with a specific surface area. The structured packing material may be used as a ring or a layer or a stack of rings or layers that have diameter that may fit into the diameter of the reactor. The ring may be an individual ring or a stack of rings fully filling the reactor. In some examples, the voids left out by the structured packing in the reactor are filled with the unstructured packing material.

Examples of structured packing material includes, without limitation, Flexipac®, Intalox®, Flexipac® HC®, etc. In a structured packing material, corrugated sheets may be arranged in a crisscross pattern to create flow channels for the vapor phase. The intersections of the corrugated sheets may create mixing points for the liquid and vapor phases. The structured packing material may be rotated about the column (reactor) axis to provide cross mixing and spreading of the vapor and liquid streams in all directions. The structured packing material may be used in various corrugation sizes and the packing configuration may be optimized to attain the highest efficiency, capacity, and pressure drop requirements of the reactor. The structured packing material may be made of a material of construction including, but not limited to, titanium, stainless steel alloys, carbon steel, aluminum, nickel alloys, copper alloys, zirconium, thermoplastic, etc. The corrugation crimp in the structured packing material may be of any size, including, but not limited to, Y designated packing having an inclination angle of 45° from the horizontal or X designated packing having an inclination angle of 60° from the horizontal. The X packing may provide a lower pressure drop per theoretical stage for the same surface area. The specific surface area of the structured packing may be between 50-800 m²/m³, for example from 75-350 m²/m³, such as from about 200-800 m²/m³, for example from 150-800 m²/m³, such as from about 500-800 m²/m³.

The systems provided herein are applicable to or can be used for any of one or more methods described herein. In some examples, the systems provided herein further include an oxygen gas delivery system operably connected to the thermal reactor. The oxygen gas delivery system is configured to provide the oxygen gas to the oxygen gas collection unit. The oxygen gas may be delivered to the oxygen gas collection unit using any means for directing the oxygen gas from the thermal reactor. Such means for directing the oxygen gas from the thermal reactor to the oxygen gas delivery system are well known in the art and include, but not limited to, pipe, duct, conduit, and the like. In some examples, the oxygen gas from the thermal reactor may be purified before being collected and optionally compressed.

In some examples, the reactor and/or the electrochemical cell and its components, as provided herein, may include a control station, configured to control one or more of the amount of the metal salt introduced into the anode chamber of the electrochemical cell, the amount of the anode electrolyte introduced into the thermal reactor or the second electrochemical cell, the temperature and pressure of the units, amount of the water, the flow rate in and out of the reactor, the time and the flow rate of the water going back to the electrochemical cell, etc.

The control station may include a set of valves or multi-valve systems which are manually, mechanically or digitally controlled, or may employ any other convenient flow regulator protocol. In some instances, the control station may include a computer interface, (where regulation is computer-assisted or is entirely controlled by computer) configured to provide a user with input and output parameters to control the amount and conditions, as described above.

The methods and systems may also include one or more detectors configured for monitoring the flow of gases or the concentration of the metal salt in the water/saltwater etc. Monitoring may include, but is not limited to, collecting data about the pressure, temperature and composition of the aqueous medium and gases. The detectors may be any convenient device configured to monitor, for example, pressure sensors (e.g., electromagnetic pressure sensors, potentiometric pressure sensors, etc.), temperature sensors (resistance temperature detectors, thermocouples, gas thermometers, thermistors, pyrometers, infrared radiation sensors, etc.), volume sensors (e.g., geophysical diffraction tomography, X-ray tomography, hydroacoustic surveyors, etc.), and devices for determining chemical makeup of the aqueous medium or the gas (e.g., IR spectrometer, NMR spectrometer, UV-vis spectrophotometer, high performance liquid chromatographs, inductively coupled plasma emission spectrometers, inductively coupled plasma mass spectrometers, ion chromatographs, X-ray diffractometers, gas chromatographs, gas chromatography-mass spectrometers, flow-injection analysis, scintillation counters, acidimetric titration, and flame emission spectrometers, etc.).

In some examples, detectors may also include a computer interface which is configured to provide a user with the collected data about the water, the metal salt and/or the salt. For example, a detector may determine the concentration of the metal salt and the computer interface may provide a summary of the changes in the composition within the water over time. In some examples, the summary may be stored as a computer readable data file or may be printed out as a user readable document.

In some examples, the detector may be a monitoring device such that it can collect real-time data (e.g., internal pressure, temperature, etc.) about the water, the metal salt, and/or the salt ions. In other examples, the detector may be one or more detectors configured to determine the parameters of the metal salt, and/or the salt ions at regular intervals, e.g., determining the composition every 1 minute, every 5 minutes, every 10 minutes, every 30 minutes, every 60 minutes, every 100 minutes, every 200 minutes, every 500 minutes, or some other interval.

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Various modifications of the invention in addition to those described herein will become apparent to those skilled in the art from the foregoing description and accompanying figures. Such modifications fall within the scope of the appended claims. Efforts have been made to ensure accuracy with respect to numbers used (e.g., amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric.

### EXAMPLES

### Example 1

### Oxidation of the Metal Salt and Generation of the Hydrogen and the Oxygen Gas

An electrochemical cell with an anode and a cathode is constructed with an anion exchange membrane separating the chambers. The cell is fed an aqueous solution of 0.4 M copper (I) chloride (CuCl), and 6 M potassium hydroxide (KOH) to the anode chamber and an aqueous solution of potassium hydroxide to the cathode chamber. A potential between 1.3 V and 3 V, depending on the total current desired, is applied between the anode and cathode, where the CuCl is oxidized to the Cu(OH)Cl at the anode and water is reduced to hydrogen gas and hydroxide at the cathode. The hydroxide ions maintain charge balance of the system by passing through the anion exchange membrane from the cathode chamber to the anode chamber. The amount of CuCl oxidized to Cu(OH)Cl is about 0.1 M.

The hydrogen from the cathode chamber is separated from the aqueous KOH solution with a vessel for gas-liquid separation. The aqueous KOH solution from the cathode chamber is reconstituted with an amount of water to replace the water that was reduced and recirculated to an intermediate feed tank that feeds the cathode chamber.

The solution from the anode chamber is passed into a thermal reactor. In this thermal reactor, the solution is heated to a higher temperature, around 100° C., to affect oxygen evolution and Cu(OH)Cl reduction, which also consumes hydroxide and generates CuCl and water. Water from this reactor is separated by condensation and some of the water is used to reconstitute the aqueous KOH solution fed to the cathode chamber. The aqueous solution of CuCl and KOH from the thermal reactor is fed back to an intermediate tank for feeding into the anode chamber.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A method to generate hydrogen gas, comprising:
providing an anode and an anode electrolyte comprising a metal salt in an electrochemical cell and oxidizing a metal ion of the metal salt from a lower oxidation state to a higher oxidation state to form a metal hydroxy salt; and
providing a cathode and a cathode electrolyte in the electrochemical cell and forming hydrogen gas and hydroxide ions at the cathode.

2. The method of claim 1, further comprising separating the anode electrolyte from the cathode electrolyte by an anion exchange membrane and migrating the hydroxide ions from the cathode electrolyte to the anode electrolyte.

3. The method of claim 1, wherein the metal ion in the metal salt or the metal hydroxy salt is selected from the group consisting of manganese, iron, chromium, selenium, copper, tin, silver, cobalt, uranium, lead, mercury, vanadium, bismuth, titanium, ruthenium, osmium, europium, zinc, cadmium, gold, nickel, palladium, platinum, rhodium, iridium, technetium, rhenium, molybdenum, tungsten, niobium, tantalum, zirconium, hafnium, and combination thereof.

4. The method of claim 1, wherein the metal salt is selected from the group consisting of CuCl, CuBr, CuI, FeCl₂, FeBr₂, FeI2, SnCl₂, SnBr₂, SnI₂, Cu₂SO₄, FeSO₄, SnSO₄, Cu₃PO₄, Fe₃(PO₄)₂, and Sn₃(PO₄)₂.

5. The method of claim 1, wherein the metal hydroxy salt is selected from the group consisting of Cu(OH)ₓCl_{y}, Cu(OH)ₓBr_{y}, Cu(OH)ₓI_{y}, Fe(OH)ₓCl_{y}, Fe(OH)ₓBr_{y}, Fe(OH)ₓI_{y}, Sn(OH)ₓCl_{y}, SN(OH)ₓBr_{y}, Sn(OH)ₓI_{y}, Cu₂(OH)ₓ(SO₄)_{y}, Fe(OH)ₓ(SO₄)_{y}, Sn(OH)ₓ(SO₄)_{y}, Cu₃(OH)ₓ(PO₄)_{y}, Fe₃(OH)ₓ(PO₄)_{y}, and Sn₃(OH)ₓ(PO₄)_{y}, wherein x and y are integers and add to balance the charge on the metal.

6. The method of claim 1, wherein the metal hydroxy salt with the metal ion in the higher oxidation state is Mₓ^{m+}X_{y}(OH)_{(mx-y)}, MₓX_{y}(OH)_{(2x-y)}, MₓX_{y}(OH)_{(3x-y)}, MₓX_{y}(OH)_{(4x-y)}, or combinations thereof, wherein M is the metal ion, X is counter anion, and m, x, and y are integers.

7. The method of claim 1, wherein a counter anion in the metal salt or the metal hydroxy salt is a halide ion, a sulfate ion, or a phosphate ion.

8. The method of claim 1, further comprising maintaining a steady-state pH differential of between about 1-6 between the anode electrolyte and the cathode electrolyte.

9. The method of claim 1, wherein no oxygen gas is formed at the anode or less than 25% of the Faradaic efficiency is for the oxygen evolution reaction at the anode.

10. The method of claim 1, further comprising oxidizing hydroxide ions at the anode to form oxygen gas.

11. The method of claim 1, further comprising:
operating the electrochemical cell at lower current density for the oxidation of the metal salt with the metal ion in the lower oxidation state to the metal hydroxy salt with the metal ion in the higher oxidation state at the anode; and
operating the electrochemical cell at higher current density for the oxidation of the hydroxide ions at the anode to form oxygen gas.

12. The method of claim 1, further comprising:
transferring at least a portion of the anode electrolyte comprising the metal hydroxy salt outside the electrochemical cell; and
subjecting the portion of the anode electrolyte comprising the metal hydroxy salt to a thermal reaction to form oxygen gas and the metal salt with the metal ion in the lower oxidation state.

13. The method of claim 12, further comprising re-circulating the metal salt with the metal ion in the lower oxidation state back to the anode electrolyte in the electrochemical cell.

14. The method of claim 12, further comprising carrying out the thermal reaction in presence of the hydroxide ions; at a pH of more than 10; and/or in presence of a catalyst.

15. The method of claim 1, further comprising:
transferring at least a portion of the anode electrolyte comprising the metal hydroxy salt outside the electrochemical cell to a second cathode electrolyte of a second electrochemical cell; and
reducing the metal hydroxy salt at a second cathode of the second electrochemical cell to form the metal salt.

16. The method of claim 15, further comprising:
migrating hydroxide ions from the second cathode electrolyte to a second anode electrolyte through an anion exchange membrane in the second electrochemical cell; and
oxidizing the hydroxide ions at a second anode in the second electrochemical cell to form oxygen gas.

17. A system to generate hydrogen gas, comprising:
an electrochemical cell comprising;
an anode and an anode electrolyte comprising a metal salt with a metal ion in a lower oxidation state, wherein the anode is configured to oxidize the metal salt with the metal ion in the lower oxidation state to a metal hydroxy salt with the metal ion in a higher oxidation state;
a cathode and a cathode electrolyte comprising water, wherein the cathode is configured to reduce water to form hydroxide ions and hydrogen gas; and
an anion exchange membrane configured to transport the hydroxide ions from the cathode electrolyte to the anode electrolyte.

18. The system of claim 17, further comprising a thermal reactor operably connected to the electrochemical cell, wherein the thermal reactor is configured to receive at least a portion the anode electrolyte comprising the metal hydroxy salt and subject the portion of the anode electrolyte to a thermal reaction to form oxygen gas and the metal salt with the metal ion in the lower oxidation state.

19. The system of claim 17, wherein the anode is further configured to oxidize the hydroxide ions at the anode to form oxygen gas.

20. The system of claim 17, further comprising:
a second electrochemical cell operably connected to the electrochemical cell, the second electrochemical cell comprising;
a second anode and a second anode electrolyte;
a second cathode and a second cathode electrolyte, wherein the second cathode electrolyte of the second electrochemical cell is configured to receive at least a portion of the anode electrolyte of the electrochemical cell comprising the metal hydroxy salt with the metal ion in the higher oxidation state, and wherein the second cathode in the second electrochemical cell is configured to reduce the metal hydroxy salt with the metal ion in the higher oxidation state to the metal salt with the metal ion in the lower oxidation state.
